(19) United States
(12) Patent Application Publication
(10) Pub. No.: US 2014/0251131 A1
(43) Pub. Date: Sep. 11, 2014

(54) PALLADIUM-ALLOYED MEMBRANES AND METHODS OF MAKING AND USING THE SAME

(71) Applicants: James Douglas Way, Boulder, CO (US); Sabina Kathleen Gade, Westminster, CO (US); Amanda Elizabeth Lewis, Golden, CO (US); Hani Walid Abu El Hawa, Golden, CO (US)

(72) Inventors: James Douglas Way, Boulder, CO (US); Sabina Kathleen Gade, Westminster, CO (US); Amanda Elizabeth Lewis, Golden, CO (US); Hani Walid Abu El Hawa, Golden, CO (US)

(21) Appl. No.: 14/201,001

(22) Filed: Mar. 7, 2014

Related U.S. Application Data
(60) Provisional application No. 61/774,458, filed on Mar. 7, 2013.

(51) Int. Cl. B01D 71/02; B01D 53/22

(52) U.S. Cl. CPC B01D 71/022; B01D 53/228
USPC 95/56; 96/4

(57) ABSTRACT

This disclosure relates to palladium-alloyed membranes, and more specifically to palladium-alloyed membranes for high temperature applications and to methods for making and using the same.

### CROSS REFERENCE TO RELATED APPLICATIONS

The present application claims the benefits of U.S. Provisional Application Ser. No. 61/744,458, filed Mar. 7, 2013, entitled “Palladium Alloy Composite Membrane and Method of Making the Same”, which is incorporated herein by this reference in its entirety.

### FIELD OF DISCLOSURE

This disclosure relates to palladium-alloyed membranes, more particularly to palladium-alloyed membranes for high temperature applications and to methods for making and using the same.

### BACKGROUND

The recent emphasis on cleaner energy technologies has focused attention on hydrogen as an alternative fuel. Currently, most hydrogen is produced from hydrocarbon sources such as natural gas, oil, and coal. Hydrogen produced from these sources usually contains residual hydrocarbons, carbon monoxide and sulfur compounds. An economic way to remove such contaminants from hydrogen is therefore desirable. Membranes made of palladium, nickel, platinum, and metallic elements of periodic table groups 3-12 are able to selectively transport hydrogen and are thus capable of separating hydrogen from residual hydrocarbons, carbon dioxide, carbon monoxide and sulfur compounds. Membrane separation technologies have the potential to reduce operating costs, minimize unit operations, and lower energy consumption. Palladium membranes are of particular note for their high permeability, tolerance to hydrocarbon-containing streams, and their ability to catalyze molecular hydrogen dissociation. Palladium membranes have a virtually infinite perm-selectivity towards hydrogen gas (H₂). This perm-selectivity allows only the hydrogen gas, and no other gaseous components, to permeate the palladium membrane, with substantially pure hydrogen (H₂) gas separated and recovered in a permeate stream. The palladium membrane retains any by-products and unconverted reactants as a retentate stream.

The commercial application of palladium membranes has been limited by several factors. When exposed to hydrogen at temperatures below 573 degrees Kelvin, pure palladium can undergo a palladium hydride embrittling phase transition. Furthermore, at temperatures above 723 degrees Kelvin, some carbon-containing compounds deactivate palladium. Moreover, sulfur-containing compounds irreversibly poison palladium. Additionally, commercial palladium foils, particularly those having a thickness greater than 25 microns are exceptionally expensive.

Therefore, there exists a need for palladium membranes capable of selectively transporting hydrogen while withstanding temperature and pressure cycles encountered in typical applications in which hydrogen purification membranes are used, and methods of efficiently and economically producing these membranes. These needs are addressed by the present disclosure.

### SUMMARY OF DISCLOSURE

In accordance with some aspects of the present disclosure are methods for separating a hydrogen-containing fluid stream into permeate and retenate streams. The hydrogen-containing fluid stream is separated at a temperature from about 573 to about 1,173 degrees Kelvin. The permeate stream substantially contains molecular hydrogen. The retenate stream is substantially depleted of molecular hydrogen compared to the hydrogen-containing fluid stream. The hydrogen-containing fluid stream is separated into permeate and retenate streams by permeating the hydrogen in the hydrogen-containing fluid stream through a palladium-alloyed membrane. The palladium-alloyed membrane has a nitrogen leakage growth rate at about 823 degrees Kelvin of no more than about 7×10⁻¹² (mol/m²/s/Pa)/h. The palladium-alloyed membrane contains palladium and one or more of ruthenium, rhodium, iridium, platinum, silver, gold and osmium.

Typically, the palladium-alloyed membrane has an average thickness of from about 0.5 to about 15 μm. More typically, the palladium-alloyed membrane has an average thickness of from about 1 to about 10 μm. Moreover, the palladium-alloyed membrane has a hydrogen permeance of from about 1×10⁻³ to about 1×10⁻² mol/m²/s/Pa^{0.5}. Furthermore, the palladium-alloyed membrane comprises palladium and one of about 0.5 wt. % ruthenium, about 17 wt. % platinum, and about 27 wt. % platinum. In some configurations, ruthenium-containing palladium-alloyed membranes have no more than about 1 mass % ruthenium.

The hydrogen-containing fluid stream is provided by one of a steam reforming reactor of a hydrocarbon, a steam reforming reactor of methane or a steam reforming reactor of an alcohol. In some configurations, the steam reforming reactor includes a catalyst for catalyzing molecular hydrogen production. The catalyst is typically in the form of one of a fluidized or packed bed.

Generally, the palladium-alloyed membrane is support on one or more surfaces of a membrane support. Typically, the membrane support is porous and permeable. Moreover, an intermetallic material is typically positioned between the palladium-alloyed membrane and the membrane support. The intermetallic material is commonly one or more of alumina, silica, zirconia, stabilized zirconias such as yttria or ceria stabilized zirconia, titania, ceria, silicon, carbide, chromium oxide, ceramic materials, and zeolites. The intermetallic material is a diffusion barrier between the membrane support and the palladium-alloyed membrane. Generally, the membrane support is the form of one of a tube, corrugated shape, a system of double-plates, a plate coiled as a double spiral, plane, a curvilinear sheet, or flat disk. Furthermore, the membrane support is selected from the group consisting of 301, 304, 305, 316, 317, and 321 series of stainless steels, HASTELLOY™ B-2, C-4, C-22, C-276, G-30, X and others, and INCONEL™ alloys 600, 625, 690, and 718.

Furthermore, the separating of the molecular hydrogen from the hydrogen-containing fluid stream is conducted in a steam reforming reactor at a pressure selected from the group of pressures consisting of from about 0.1 to about 10 MPa, from about 0.5 to about 5 MPa, from about 1 to about 3 MPa, and from about 2 to about 3 MPa. Moreover, the separating of the molecular hydrogen from the hydrogen-containing fluid stream is conducted in a steam reforming reactor at a temperature is selected from the group of temperatures consisting of from about 673 to about 1,173 degrees Kelvin, from about 773 to about 1,073 degrees Kelvin and from about 773 to about 973 degree Kelvin. Furthermore, the separating of the molecular hydrogen from the hydrogen-containing fluid stream is conducted in a steam reforming reactor at a space velocity selected from the group of space velocities consisting of from about 60 to about 900 GHSV (h⁻¹), from about 70 to about 800 GHSV (h⁻¹), and from about 100 to about 700 GHSV (h⁻¹). In some configurations the separating of the molecular hydrogen from the hydrogen-containing fluid stream is conducted in a steam reforming reactor at a pressure from about 0.1 to about 10 MPa and a space velocity of from about 50 to about 1,000 GHSV (h⁻¹).

Typically, the permeated molecular hydrogen stream has at least about 80 mole % molecular hydrogen. Moreover, after about 900 hours or more of permeating hydrogen through the palladium-alloyed membrane the permeated molecular hydrogen stream comprises at least about 90 mole % molecular hydrogen. In some configurations, the permeated molecular hydrogen stream has at least about 98 mole % molecular hydrogen after about 900 hours or more of permeating hydrogen through the palladium-alloyed membrane.

In accordance with some aspects of the present disclosure are palladium-alloyed membranes having an average thickness of from about 1 to about 10 μm and a nitrogen leakage growth rate at about 823 degrees Kelvin or more of no more than about 7×10⁻¹² (mol/m²/s/Pa)/h. The palladium-alloyed membranes contain palladium and one or more of ruthenium, platinum, silver, gold and osmium. Moreover, the palladium-alloyed membranes have a hydrogen permeance of from about 1×10⁻³ to about 1×10⁻² mol/m²/s/Pa^{0.5}. Furthermore, the palladium-alloyed membrane comprises palladium and one of about 0.5 wt. % ruthenium, about 17 wt. % platinum, and about 27 wt. % platinum. In some configurations, ruthenium-containing palladium-alloyed membranes have no more than about 1 mass % ruthenium.

In accordance with some aspects of the present disclosure are methods for purifying a fluid. The methods include providing a gaseous fluid stream comprising molecular hydrogen, water, and one or both of carbon dioxide and carbon monoxide, and contacting a palladium-alloyed membrane having a nitrogen leakage growth rate at about 823 degrees Kelvin of no more than about 7×10⁻¹² (mol/m²/s/Pa)/h with the gaseous fluid stream. The contacting of the gaseous fluid steam the palladium-alloyed membrane occurs at a temperature of from about 573 to about 1,173 degrees Kelvin, and separates the gaseous fluid stream into a permeate stream comprising substantially molecular hydrogen and a retenate stream substantially depleted of the molecular hydrogen.

Furthermore, the contacting of the gaseous fluid stream with the palladium-alloyed membrane is in a steam reforming reactor at a pressure selected from the group of pressures consisting of from about 0.1 to about 10 MPa, from about 0.5 to about 5 MPa, from about 1 to about 3 MPa, and from about 2 to about 3 MPa. Moreover, the contacting of the gaseous fluid stream with the palladium-alloyed membrane is in a steam reforming reactor at a temperature selected from the group of temperatures consisting of from about 673 to about 1,173 degrees Kelvin, from about 773-1,073 degrees Kelvin and from about 773 to about 973 degree Kelvin. Furthermore, the contacting of the gaseous fluid stream with the palladium-alloyed membrane is in a steam reforming reactor at a space velocity selected from the groups of space velocities consisting of from about 60 to about 900 GHSV (h⁻¹), from about 70 to about 800 GHSV (h⁻¹), and from about 100 to about 700 GHSV (h⁻¹). In some configurations, the contacting of the gaseous fluid stream with the palladium-alloyed membrane is at a pressure from about 0.1 to about 10 MPa and a space velocity of from about 50 to about 1,000 GHSV (h⁻¹).

The palladium-alloyed membrane contains palladium and one or more of ruthenium, rhodium, iridium, platinum, silver, gold and osmium.

The permeate stream generally has at least about 80 mole % molecular hydrogen. Moreover, after about 900 hours or more of separating the gaseous fluid stream into permeate and retenate streams, the permeate stream has at least about 90 mole % molecular hydrogen. In some configurations, the permeate stream has at least about 98 mole % molecular hydrogen after about 900 hours or more of separating the gaseous fluid stream into permeate and retenate streams.

Typically, the gaseous fluid stream is provided by one of a steam reforming reactor of a hydrocarbon, a steam reforming reactor of methane or a steam reforming reactor of an alcohol.

Commonly, the palladium-alloyed membrane is support on one or more surfaces of a membrane support. The membrane support is typically porous and permeable. Moreover, an intermetallic material is generally positioned between the palladium-alloyed membrane and the membrane support. The intermetallic material is one or more of alumina, silica, zirconia, stabilized zirconias such as yttria or ceria stabilized zirconia, titania, ceria, silicon, carbide, chromium oxide, ceramic materials, and zeolites. The intermetallic material is a diffusion barrier between the membrane support and the palladium-alloyed membrane. Generally, the membrane support is the form of one of a tube, a corrugated shape, a system of double-plates, a plate coiled as a double spiral, plane, a curvilinear sheet, or flat disk. Furthermore, the membrane support is selected from the group consisting of 301, 304, 305, 316, 317, and 321 series of stainless steels, HASTELLOY™ B-2, C-4, C-22, C-276, G-30, X and others, and INCONEL™ alloys 600, 625, 690, and 718.

The palladium-alloyed membrane commonly has an average thickness of from about 0.5 to about 15 μM. More commonly, the palladium-alloyed membrane has an average thickness of from about 1 to about 10 μm. Moreover, the palladium-alloyed membrane has a hydrogen permeance of from about 1×10⁻³ to about 1×10⁻² mol/m²/s/Pa^{0.5}. Furthermore, the palladium-alloyed membrane comprises palladium and one of about 0.5 wt. % ruthenium, about 17 wt. % platinum, and about 27 wt. % platinum. In some configurations, ruthenium-containing palladium-alloyed membranes have no more than about 1 mass % ruthenium.

In accordance with some aspects of the present disclosure are devices having a shell, a membrane position in the shell to form a permeate volume and a renate volume, an inlet configured for introducing a first gaseous stream to the permeate volume, and a first outlet configured to exhaust substantially pure molecular hydrogen from the permeate volume. The membrane is a palladium-alloyed membrane having a nitrogen leakage growth rate at about 823 degrees Kelvin or more of no more than about 7×10⁻¹² (mol/m²/s/Pa)/h.

An aspect of the present disclosure is a method for making palladium-alloyed membranes for high temperature applications. The method includes depositing palladium and an alloying metal on a membrane support to form a deposited layer on the membrane support. Palladium and the alloy metal can be deposited by one of the following: electrolessly plating, thermal deposition, chemical vapor deposition, electroplating, spray deposition, sputter coating, e-beam evaporation, ion beam evaporation, magnetron sputtering and spray pyrolysis. The deposited layer is annealed at a temperature from about 773 to 973 degrees Kelvin to form a palladium-alloyed membrane on the membrane support. After annealing, the palladium and alloying metals are substantially distributed throughout the palladium-alloyed membrane. In some embodiments, the palladium and alloying metal are electrolessly deposited at substantially the same time from an electroless bath containing palladium and the alloying metal. In some embodiments, the palladium and alloying metals are sequentially electrolessly deposited one after the other. The sequential electroless deposition is carrying out using multiple electroless bath. For example, palladium is electrolessly deposited on the membrane support from a palladium electroless bath and the alloying metal is deposited on the membrane support from an alloying metal electroless bath. Commonly, the alloying metal is one of silver, gold, copper, platinum, rhodium, iridium, ruthenium, osmium, or a mixture thereof.

Another aspect of the present disclosure is a method for separating molecular hydrogen from a fluid stream using the palladium-alloyed membrane. The method includes providing a first fluid stream having a first volume % of molecular hydrogen (H₂) and one or more of a hydrocarbon compound, water, carbon dioxide, and carbon monoxide, and contacting a palladium-alloyed membrane having from about 99.8 mass % to about 70 mass % palladium and from about 0.2 mass % to about 30 mass % of an alloying metal with the first fluid stream to form a second fluid stream having more than about 90 mole % molecular hydrogen. The palladium-alloyed membrane commonly has opposing first and second membrane sides. The first fluid stream is typically adjacent to the first membrane side and the second fluid stream is typically adjacent to the second membrane side. Preferably, the palladium-alloyed membrane has a hydrogen permeance or flux/driving force from about 0.001 to about 0.01 mol/m²·s·Pa^{0.5}. These and other advantages will be apparent from this disclosure.

As used herein “high temperature” and/or “high operating temperature” generally refers to a temperature of one of about 573 degrees Kelvin or more, about 673 degrees Kelvin or more, about 773 degrees Kelvin or more, about 823 degrees Kelvin or more, or about 973 degrees Kelvin or more. Furthermore, “high temperature” and/or “high operating temperature” can refer to a temperature range from one of about 573 degrees Kelvin or more, of about 673 degrees Kelvin or more, of about 773 degrees Kelvin or more, of about 823 degrees Kelvin or more, or of about 973 degrees Kelvin or more to a temperature of one of about 1,500 degrees Kelvin or less, of about 1,173 degrees Kelvin or less, of about 1,073 degrees Kelvin or less, of about 973 degrees Kelvin or less, or of about 873 degrees Kelvin or less.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples.

Further features and advantages will become apparent from the following, more detailed, description of the various embodiments of the disclosure, as illustrated by the drawings referenced below.

FIG. 1 depicts methane conversion level versus gas head space velocity of methane for steam reforming of methane in a membrane reactor according to the present disclosure;

FIG. 2 depicts an elevation view of a palladium-alloyed membrane on a membrane support of the present disclosure;

FIG. 3 depicts nitrogen leakage rate versus time for a palladium-alloyed membrane of the present disclosure;

FIG. 4 depicts hydrogen flux versus the inverse of membrane thickness for unalloyed palladium membranes of the prior art and palladium-alloyed membranes of the present disclosure;

FIG. 5 depicts the hydrogen permeability versus mass % platinum in a palladium-alloyed membrane alloyed with platinum of the present disclosure;

FIG. 6 depicts a comparison of hydrogen permeance at about 873 degrees Kelvin for an unalloyed palladium membrane and a palladium-alloyed membrane of the presence disclosure;

FIG. 7 depicts nitrogen flux versus time data at 823 and 873 degrees Kelvin for a palladium-alloyed membrane of the disclosure;

FIG. 8 depicts a process for using a palladium-alloyed membrane of the present disclosure;

FIG. 9 depicts plan cross-section of a palladium-alloyed membrane of the present disclosure;

FIG. 10 depicts calculated percent methane conversion levels for a conventional, equilibrium steam reforming reactor and for a steam reforming reactor using a palladium-alloyed membrane of the present disclosure;

FIG. 11 depicts a membrane test apparatus of the present disclosure;

FIG. 12A is a scanning electron micrograph a cross-sectioned palladium-alloyed membrane of the present disclosure containing about 27 wt % platinum;

FIG. 12B depicts platinum and palladium level scans for the palladium-alloyed membrane of FIG. 12A;

FIG. 12C is a scanning electron micrograph a cross-sectioned unalloyed palladium membrane of the present disclosure;

FIG. 12D is a scanning electron micrograph a cross-sectioned palladium-alloyed membrane of the present disclosure containing about 0.3 wt. % ruthenium;

FIG. 13 shows hydrogen gas permeation flux versus driving force at four different temperatures for an unalloyed palladium membrane of the present disclosure;

FIG. 14 shows long-term permeance and leakage data for a first unalloyed palladium membrane control of the present disclosure;

FIG. 15 shows long-term permeance and leakage data for a second unalloyed palladium membrane control of the present disclosure;

FIG. 16 depicts permeance and leakage data for a palladium-alloyed membrane having ruthenium of the present disclosure;

FIG. 17 shows permeance and leakage data for a palladium-alloyed membrane having about 27 wt. % platinum of the present invention;

FIG. 18A shows an image of an unalloyed palladium control membrane after quenching in a hydrogen atmosphere;

FIG. 18B shows an image of palladium-alloyed membrane having about 27 wt. % platinum after quenching in a hydrogen atmosphere;

FIG. 18C is a scanning electron microscope image of a palladium-alloyed membrane having about 27 wt. % platinum surface after quenching in hydrogen;

FIG. 19 shows a comparison of the rate of nitrogen leakage growth rates for unalloyed palladium membranes and palladium-alloyed membranes of the present disclosure;

FIG. 20 shows a comparison of the hydrogen permeability for unalloyed palladium membranes and palladium-alloyed membranes of the present disclosure;

FIG. 21 shows a comparison of the hydrogen permeance and nitrogen leakage data for an unalloyed palladium membrane and two palladium-alloyed membranes of the present disclosure; and

FIG. 22 shows a comparison of nitrogen leakage data for an unalloyed palladium membrane and a palladium-alloyed membrane containing ruthenium at about 823 and about 873 degrees Kelvin of the present disclosure.

### DETAILED DESCRIPTION

In accordance with some embodiments of this disclosure are palladium-alloyed membranes having improved performance properties and methods for making and using the same. Furthermore, some embodiments of this disclosure include systems and devices comprising the palladium-alloyed membranes disclosed herein.

Palladium-containing membranes for separating and purifying molecular hydrogen (H₂) in high temperature environments lack long-term temperature stability. For example, palladium-containing membranes typically develop leakage. The leakage allows one or more gaseous components other than hydrogen to pass through the palladium-containing membrane, thereby decreasing the hydrogen (H₂) perm-selectivity of the palladium-containing membrane.

Palladium-alloyed membranes having improved performance properties at high operating temperatures were unexpectedly found. The unexpected improved high temperature performance properties allow for the palladium-alloyed membrane to be operated at one or more of a high operating temperature, a stable permeate flux, a high permeate purity level, and a longer period of time. Moreover, molecular hydrogen producing reactors containing the palladium-alloyed membrane can be operated at one or more of a higher conversation level, a higher space velocity, and under non-equilibrium conditions.

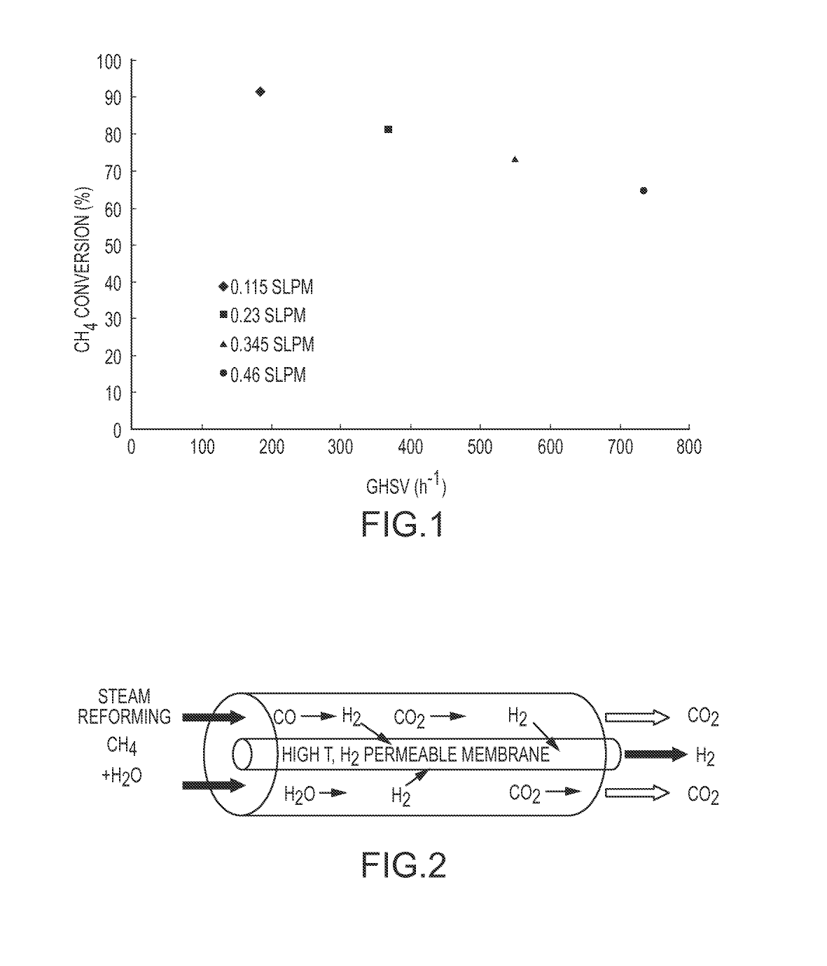

While not wanting to be limited by example, a 5.0 μm thick palladium-alloyed membrane having about 0.5 wt. % ruthenium in a steam reforming of methane operation had an unexpectedly stable permeate flux after more than about 1,000 hours of operation at an average temperature of about 823 degrees Kelvin. Furthermore, the hydrogen permeate purity was more than 90 mole %. The palladium-alloyed membrane was prepared by electrolessly plating of palladium and ruthenium on a zirconium oxide coated porous stainless steel tube support manufactured by Pall Corporation. The stream reforming of methane was carried out over a nickel-based catalyst at about a pressure of 2.9 MPa. Conversion levels for the steam reforming of methane varied with the reactor space velocity (as shown in FIG. 1). Conversion levels were from about 65 to more than about 90 mole % at reactor space velocities of from about 100 to about 800 GHSV (h⁻¹), where GHSV (h⁻¹) is the reactant, in this case methane, gas volumetric flow rate divided by reactor catalyst volume per hour. The methane flow rate in the reactor at these space velocities corresponded to from about 0.1 to about 0.5 slpm, where slpm refers to standard liters per minute at a temperature of 823 degrees Kelvin and a pressure of 2.9 MPa. The steam to carbon ratio was about 3. While not wanting to be limited by theory, it is believed that the high methane conversion rates are due to one or both of the high temperature stability of the palladium-alloyed membrane and the ability to conduct the steam reforming in a non-equilibrium condition.

Palladium-alloyed membranes having improved performance properties can substantially enhance molecular hydrogen separation processes. Moreover, palladium-alloyed membranes can substantially enhance the process of separating molecular hydrogen at high temperatures. Separated hydrogen (H₂) gas purity levels typically of about 85 mole % or more, more typically of about 90 mole % or more, even more typically of about 92 mole % or more, yet even more typically of about 95 mole % or more, still yet even more typically of about 98 mole % or more, still yet even more typically of about 99 mole % or more, or yet still even more typically of about 99.9 mole % or more can be obtained at a temperature range of one of from about 573 degrees Kelvin to about 1,173 degrees Kelvin, from about 573 degrees Kelvin to about 973 degrees Kelvin, from about 673 degrees Kelvin to about 973 degrees Kelvin, or from about 823 degrees Kelvin to about 973 degrees Kelvin. Moreover, separated molecular hydrogen (H₂) gas purity levels typically of about 85 mole % or more, more typically of about 90 mole % or more, even more typically of about 92 mole % or more, yet even more typically of about 95 mole % or more, still yet even more typically of about 98 mole % or more, still yet even more typically of about 99 mole % or more, or yet still even more typically of about 99.9 mole % or more can be obtained at a differential pressure range across the palladium-alloyed membrane of one of from about 0.001 to about 10 MPa, from about 0.01 to about 7 MPa, from about 0.02 to about 4 MPa, or from about 0.03 to about 4 MPa.

Furthermore, palladium-alloyed membranes can operate at a temperature range of one of from about 573 degrees Kelvin to about 1,173 degrees Kelvin, from about 573 degrees Kelvin to about 973 degrees Kelvin, from about 673 degrees Kelvin to about 973 degrees Kelvin, or from about 823 degrees Kelvin to about 973 degrees Kelvin and at a differential pressure across the palladium-alloyed membrane of one of from about 0.001 to about 10 MPa, from about 0.01 to about 7 MPa, from about 0.02 to about 4 MPa, or from about 0.03 to about 4 MPa for one of about 900 hours or more, about 1,000 hours or more, about 1,200 hours or more, about 1,500 hours or more, or about 2,000 hours or more and produce a separated molecular (H₂) gas stream having a purity level of about 85 mole % or more, more typically of about 90 mole % or more, even more typically of about 92 mole % or more, yet even more typically of about 95 mole % or more, still yet even more typically of about 98 mole % or more, still yet even more typically of about 99 mole % or more, or yet still even more typically of about 99.9 mole % or more. Furthermore, the palladium-alloyed membrane can operate at a temperature range of one of from about 573 degrees Kelvin to about 1,173 degrees Kelvin, from about 573 degrees Kelvin to about 973 degrees Kelvin, from about 673 degrees Kelvin to about 973 degrees Kelvin, or from about 823 degrees Kelvin to about 973 degrees Kelvin for one of about 900 hours or more, about 1,000 hours or more, about 1,200 hours or more, about 1,500 hours or more, or about 2,000 hours or more and produce a separated molecular (H₂) gas stream having a purity level of about 85 mole % or more, more typically of about 90 mole % or more, even more typically of about 92 mole % or more, yet even more typically of about 95 mole % or more, still yet even more typically of about 98 mole % or more, still yet even more typically of about 99 mole % or more, or yet still even more typically of about 99.9 mole % or more.

While not wanting to be limited by example, the palladium-alloyed membrane can provide enhanced hydrogen separation and purification at least the temperatures, pressures, and space velocities listed in Table I. While not wanting to be limited by

TABLE I

| | Pressure Across | |
|---|---|---|
| Temperature | Membrane | Space Velocity |
| degrees Kelvin | MPa | GHSV (h⁻¹) |
| 573-1,173 | 0.001-10 | 50-1,000 |
| 573-973 | 0.01-7 | 60-900 |
| 673-973 | 0.02-5 | 70-800 |
| 823-973 | 0.03-4 | 100-700 |

example, the palladium-alloyed membrane can provide enhanced molecular hydrogen (H₂) separation during steam reforming at the temperatures, pressures and space velocities given in Table I. The steam reforming can be one of a hydrocarbon, a steam reforming of methane, a steam reforming of ammonia, a steam reforming of coal, a steam reforming of a biomass, or a steam reforming of an alcohol. The temperatures, pressures and space velocities can be those of a steam reforming reactor or of a gas stream provided by the reactor to a gas separation unit operation. Conversion levels of commonly from about 25 to about 100 mole %, more commonly from about 35 to about 98 mole %, even more commonly from about 45 to 97 mole %, or yet even more commonly from about 60 to about 95 mole % can be obtained for any combination of one or more of the temperature, pressure and space velocity ranges given in Table I. Separated hydrogen (H₂) gas purity level of typically of about 80 mole % or more, more typically of about 85 mole % or more, even more typically of about 90 mole % or more, yet even more typically of about 92 mole % or more, still yet even more typically of about 95 mole % or more, still yet even more typically of about 98 mole % or more, still yet even more typically of about 99 mole % or more, or yet still even more typically of about 99.9 mole % or more can be obtained for any combination of one or more of the temperature, pressure and space velocity ranges given in Table I. Moreover, a steam reforming reactor and/or gas separating unit operation in fluid communication with the steam reforming reactor can operate at any combination of the steam reforming reactor temperature, pressure and space velocity ranges given in Table I can achieve a conversion level of one of from 25 to about 100%, from about 35 to about 98%, from about 45 to 97%, or from about 60 to about 95% and hydrogen gas (H₂) purity level of one of about 90 mole % or more, of about 92 mole % or more, of about 95 mole % or more, of about 98 mole % or more, of about 99 mole % or more, or of about 99.9 mole % or more.

Furthermore, the palladium-alloyed membrane can operate for one of about 900 hours or more, about 1,000 hours or more, about 1,200 hours or more, about 1,500 hours or more, or about 2,000 hours or more at any combination of one or more of the temperature, pressure and space velocity ranges given in Table I and have one or both of a conversion level of one of from 25 to about 100%, from about 35 to about 98%, from about 45 to 97%, or from about 60 to about 95% and a hydrogen gas (H₂) purity level of one of about 90 mole % or more, of about 92 mole % or more, of about 95 mole % or more, of about 98 mole % or more, of about 99 mole % or more, or of about 99.9 mole % or more.

The separation of the molecular hydrogen (H₂) gas can occur in the steam reforming reactor or in a vessel other than the steam reforming reactor. For example, the molecular hydrogen gas can be generated in the steam reforming reactor and separated in a gas separation unit, the steam reforming reactor and gas separation unit being in fluid communication. The gas separation unit and the steam reforming reactor are in fluid communication with the steam reforming reactor providing a fluid stream to the gas separation unit, but the gas separation unit does not return any fluid to the steam reforming reactor.

However, some configurations can be envisioned where the steam reforming reactor and the gas separation unit are interconnected in parallel. In such instances, the steam reforming reactor provides a fluid stream to the gas separation unit. The gas separation unit separates the fluid stream into a permeate stream, containing substantially molecular hydrogen, and retenate stream gas. It can be appreciated that the retenate stream can contain unreacted reactants that can be converted by the steam reforming operation into molecular hydrogen. Some, or all, of the retenate stream can be returned to the steam reforming reactor. It can appreciate that the permeate stream is generally not returned to steam reforming reactor.

Furthermore, the palladium-alloyed membrane can be utilized to separate molecular hydrogen from petroleum refining streams containing molecular hydrogen and/or petrochemical processing plant streams contain molecular hydrogen.

The palladium-alloyed membrane is typically supported upon a membrane support. The membrane support may be of any shape or geometry. The membrane support is generally configured to maximize the palladium-alloyed membrane surface area. Suitable shapes can include without limitation planar or curvilinear sheets of the having an undersurface and a top surface that together define a sheet thickness, or the shapes can be tubular (as shown in FIG. 2), such as, for example, rectangular, square and circular tubular shapes that have an inside surface and an outside surface that together define a wall thickness and with the inside surface of the tubular shape defining a tubular conduit. The membrane support is commonly a flat disk or a tube, more commonly the membrane support is tube. While not wanting to be limited by example, tubular shaped membrane supports typically have a diameter of about 1 cm or more. However, the membrane support can be in the form of hollow fibers. The hollow fibers commonly have a diameter from about 100 microns to about 0.01 cm. Other suitable shapes in a corrugate shape, a system of double-plates, or a plate coiled as a double spiral to name a few.

One or more palladium-alloyed membranes may be mounted in a shell to form a gas separator unit and/or steam reforming reactor. The one or more palladium-alloyed membranes may be mounted in the shell in any configuration, including without limitation any tube or tubes in shell configuration, or any corrugated shape in shell configuration.

The one or more palladium-alloyed membranes mounted in the shell typically define one or more permeate volumes and one or more retenate volumes. The steam reforming reactants and by-products retained by the palladium-alloyed membrane and occupy the retenate volume. The retenate volume can substantially comprise carbon dioxide. The permeate volume substantially comprises molecular hydrogen (H₂).

The steam reforming reactor may include a catalyst for catalyzing one or more of the steam reforming reactions that produce molecular hydrogen (H₂). The catalyst can be included in the palladium-alloyed membrane and/or can occupy some of the retenate volume. Moreover, the catalyst can be in the form of a fluidized bed within the retenate volume. Non-limiting examples of suitable catalysts are nickel calcium phosphate, nickel oxide, cerium oxide, platinum, palladium-alumina, and chromium-alumia.

The membrane support is usually porous. The membrane support can include any porous material that is suitable for use as a support for the palladium-alloyed membrane.

The membrane support can be a porous ceramic. Non-limiting examples of suitable porous ceramics are alumina, titania, zirconia and other non-oxide ceramic materials. Typically, the membrane support has a pore size from about 0.005 to about 1 microns, more typically from about 0.05 to about 0.5 microns.

The membrane support can be any material known to those having an ordinary skill in the art. The membrane support is typically fabricated and/or formed to be porous and permeable. Examples of suitable membrane support materials that can be fabricated and/or formed into suitable porous and/or permeable supports include, without limitation, stainless steels, such as, for example, the 301, 304, 305, 316, 317, and 321 series of stainless steels, HASTELLOY™ alloys, for example, HASTELLOY™ B-2, C-4, C-22, C-276, G-30, X and others, and INCONEL™ alloys, for example, INCONEL™ alloy 600, 625, 690, and 718. Moreover, the membrane support can comprise an alloy that is hydrogen permeable. The membrane support can comprise iron and chromium. Moreover, the membrane support can further comprise an additional alloy metal selected from the group consisting of nickel, manganese, molybdenum and any combination thereof. While not wanting to limited by example, the membrane support can comprise in some configurations one of: (a) nickel in an amount in the range of upwardly to about 70 weight percent of the total weight of the alloy and chromium in an amount in the range of from 10 to 30 weight percent of the total weight of the alloy; or (b) nickel in the range of from 30 to 70 weight percent, chromium in the range of from 12 to 35 weight percent, and molybdenum in the range of from 5 to 30 weight percent, with these weight percents being based on the total weight of the alloy. The membrane support can be an asymmetric ceramic filter support where the surface in contact with the palladium-alloyed membrane has a smaller pore size the opposing surface.

The membrane support commonly has a thickness in the range of from about 0.1 to about 25 mm. More commonly, the thickness is in the range of from 1 mm to 15 mm, even more commonly from 2 mm to 12.5 mm, and yet even commonly in the range from 3 to 10 mm.

Furthermore, the membrane support typically has a porosity value in the range of from 0.01 to about 0.99. The term porosity is defined as the proportion of non-solid volume to the total volume (i.e. non-solid and solid) of the porous metal substrate material. A more typical porosity is in the range of from 0.05 to 0.8, and even more typically in the range of from 0.1 to 0.6. Moreover, the membrane support can have a pore size typically from about 0.05 to about 5 microns, more commonly from about from about 0.2 to about 2.5 microns.

Moreover, the membrane support can have an intermetallic layer applied to one or more surfaces of the membrane support. The intermetallic layer is typically positioned between the membrane support and the palladium-alloyed membrane. Furthermore, the palladium-alloyed membrane is typically supported on the intermetallic layer. The intermetallic layer one or both of physically separated the palladium-alloyed membrane from the membrane support and provided an average pore-size of no greater than the membrane support pore size. It can be appreciated that the membrane support and intermetallic layer are stable under the conditions of one or both of molecular hydrogen formation, such as in steam reforming, and molecular hydrogen separation by the palladium-alloyed membrane.

The intermetallic layer can include, without limitation alumina, silica, zirconia, stabilized zirconias such as yttria or ceria stabilized zirconia, titania, ceria, silicon, carbide, chromium oxide, ceramic materials, and zeolites. The intermetallic layer can comprise zirconia stabilized with yttria, in particular zirconia stabilized with 6 to 8 wt % yttria. Moreover, in addition to yttria, ceria can further increase stabilization.

While not wanting to be limited by any theory, the intermetallic layer on the membrane support can prevent particulates from diffusing into the palladium-alloyed membrane. Furthermore, the thermal expansion coefficients of intermetallic layer and the membrane support are commonly substantially about equal, more commonly the thermal expansion coefficients differ by no more than about 200%, even more commonly the thermal expansion coefficients differ by no more than about 100%, yet even more commonly the thermal expansion coefficients differ by no more than about 50%, or still yet even more commonly the thermal expansion coefficients differ by no more than about 25%.

A substantially stable gas leakage rate is one of the improved properties of the palladium-alloyed membranes. In particular, a substantially stable gas leakage rate at high operating temperatures is one of the unexpected improved properties of the palladium-alloyed membranes. The high temperature stability of the palladium-alloyed membrane can refer to changes in the gas leakage rate of the palladium-alloyed membrane over time with respect to an unalloyed palladium membrane. The palladium-alloyed membrane generally has a leakage rate increase of no more than about 25% of the unalloyed palladium membrane. More generally, the palladium-alloyed membrane has leakage rate increase of no more than an about 20%, even more generally of no more than about 15%, yet even more generally of no more than about 10%, still yet even more generally of no more than about 1%, or yet still even more generally of no more than about 0.5% of the unalloyed palladium membrane. Moreover, the palladium-alloyed membrane has a leakage rate of from about 0.1 to about 10% of that of an unalloyed palladium membrane. It can be appreciated that the leakage rates are determined at about the same temperatures for the alloyed and unalloyed palladium membranes and for membranes having substantially about the same membrane thicknesses. Furthermore, the leakage rates are commonly determined using nitrogen and/or helium gases.

Furthermore, the palladium-alloyed membranes can have a high temperature gas leakage growth rate, as determined at about 823 degrees Kelvin for nitrogen gas, commonly of no more than about 8×10⁻¹¹ (mol/m²/s/Pa)/h, more commonly of no more than about 2×10⁻¹¹ (mol/m²/s/Pa)/h.

The high temperature stability, such as without limitation a substantially stable high temperature gas leakage rate, can be achieved by alloying palladium with one or more metals. Palladium-alloyed membranes comprising palladium (melting temperature of about 1,555 degrees Celsius) and a higher melting point metal such as one or more of iridium (melting temperature of about 2,447 degrees Celsius), osmium (melting temperature of about 3,027 degrees Celsius), ruthenium (melting temperature of about 2,334 degrees Celsius), rhodium (melting temperature of about 1,963 degrees Celsius), and platinum (melting temperature of about 1,768 degrees Celsius) can have substantially high temperature stability, particularly in comparison to unalloyed palladium.

The palladium-alloyed membrane can be a binary alloy comprising palladium and one of platinum, rhodium, iridium, ruthenium or osmium. The palladium-alloyed membrane can be a ternary alloy comprising palladium and two of platinum, rhodium, iridium, ruthenium and osmium. The palladium-alloyed membrane can be a quaternary alloy comprising palladium and three of platinum, rhodium, iridium, ruthenium and osmium. The palladium-alloyed membrane can be a highly alloyed membrane comprising palladium and four or more of platinum, rhodium, iridium, ruthenium and osmium.

Moreover, the palladium-alloyed membrane can be a binary alloy comprising palladium and one of silver, gold, platinum, rhodium, iridium, ruthenium or osmium. The palladium-alloyed membrane can be a ternary alloy comprising palladium and two of silver, gold, platinum, rhodium, iridium, ruthenium and osmium. The palladium-alloyed membrane can be a quaternary alloy comprising palladium and three of silver, gold, platinum, rhodium, iridium, ruthenium and osmium. The palladium-alloyed membrane can be a highly alloyed membrane comprising palladium and four or more of silver, gold, platinum, rhodium, iridium, ruthenium and osmium.

Palladium-alloyed membranes comprising palladium and ruthenium can have substantially stable high temperature gas leakage rates. Moreover, palladium-alloyed membranes comprising palladium and ruthenium can have substantially smaller high temperature leakage rate increases in comparison to an unalloyed palladium membrane. Commonly, substantially smaller high temperature leakage rate increases can be achieved at ruthenium alloying-levels of no more than about 5 wt. % ruthenium. More commonly, substantially smaller high temperature leakage rate increases of the palladium-alloyed membrane can be achieved at ruthenium alloying-levels of no more than about 4.5 wt. % ruthenium, even more commonly at alloying-levels of no more than about 4 wt. % ruthenium, yet even more commonly at alloying-levels of no more than about 3 wt. % ruthenium, still yet even more commonly at alloying-levels of no more than about 2 wt. % ruthenium, still yet even more commonly at alloying-levels of no more than about 1 wt. % ruthenium, still yet even more commonly at alloying-levels of no more than about 0.5 wt. % ruthenium, or yet still even more commonly at alloying levels of no more than about 0.3 wt. % ruthenium. The palladium-alloyed membrane comprising palladium and ruthenium generally has a stable gas leakage rate of at about 823 degrees Kelvin for nitrogen gas of no more than about 8×10⁻¹¹ (mol/m²/s/Pa)/h, more generally of no more than about 2×10⁻¹¹ (mol/m²/s/Pa)/h.

Furthermore, palladium-alloyed membranes comprising palladium and platinum can have substantially stable high temperature gas leakage rates. Moreover, palladium-alloyed membranes comprising palladium and platinum can have substantially smaller high temperature leakage rate increases in comparison to an unalloyed palladium membrane. Typically, substantially smaller high temperature leakage rate increases of the palladium-alloyed membrane can be achieved at platinum alloying-levels from about 5 to about 40 wt. % platinum. More typically, substantially smaller high temperature leakage rate increases of the palladium-alloyed membrane can be achieved at platinum alloying-levels from about 10 to about 35 wt. % platinum, even more commonly at alloying-levels from about 15 to about 15 wt. % platinum, yet even more commonly at alloying-levels from about 16 to about 28 wt. % platinum, or yet still even more commonly at alloying-levels from about 17 to no more than about 28 wt. % platinum. The palladium-alloyed membrane comprising palladium and platinum typically has a stable gas leakage rate of at about 823 degrees Kelvin for nitrogen gas of no more than about 8×10⁻¹¹ (mol/m²/s/Pa)/h, more typically of no more than about 2×10⁻¹¹ (mol/m²/s/Pa)/h.

Moreover, substantially stable high temperature leakage rate increases of the palladium-alloyed membrane can generally be achieved at platinum alloying-levels of from about 24 to about 30 wt. % platinum. More generally, substantially stable temperature leakage rate increases of the palladium-alloyed membrane can be achieved at platinum alloying-levels from about 25 to about 29 wt. % platinum, even more generally at alloying-levels from about 26 to about 28 wt. % platinum, or even yet more generally at alloying-levels of about 27 wt. % platinum.

Moreover, substantially stable high temperature leakage rate increases of the palladium-alloyed membrane can typically be achieved at platinum alloying-levels of from about 14 to about 24 wt. % platinum. More typically, substantially stable high temperature leakage rate increases of the palladium-alloyed membrane can be achieved at platinum alloying-levels from about 18 to about 20 wt. % platinum, even more typically at alloying-levels from about 16 to about 18 wt. % platinum, or even yet more typically at alloying-levels of about 17 wt. % platinum.

Furthermore, palladium-alloyed membranes comprising palladium and rhodium can have substantially stable high temperature leakage rate increases in comparison to an unalloyed palladium membrane. Typically, substantially smaller high temperature leakage rate increases of the palladium-alloyed membrane can be achieved at rhodium alloying-levels from about 0.1 to about 20 mass % rhodium, more typically form about 0.5 to about 5 mass % rhodium. The palladium-alloyed membrane comprising palladium and rhodium typically has a stable gas leakage rate of at about 823 degrees Kelvin for nitrogen gas of no more than about 8×10⁻¹¹ (mol/m²/s/Pa)/h, more typically of no more than about 2×10⁻¹¹ (mol/m²/s/Pa)/h.

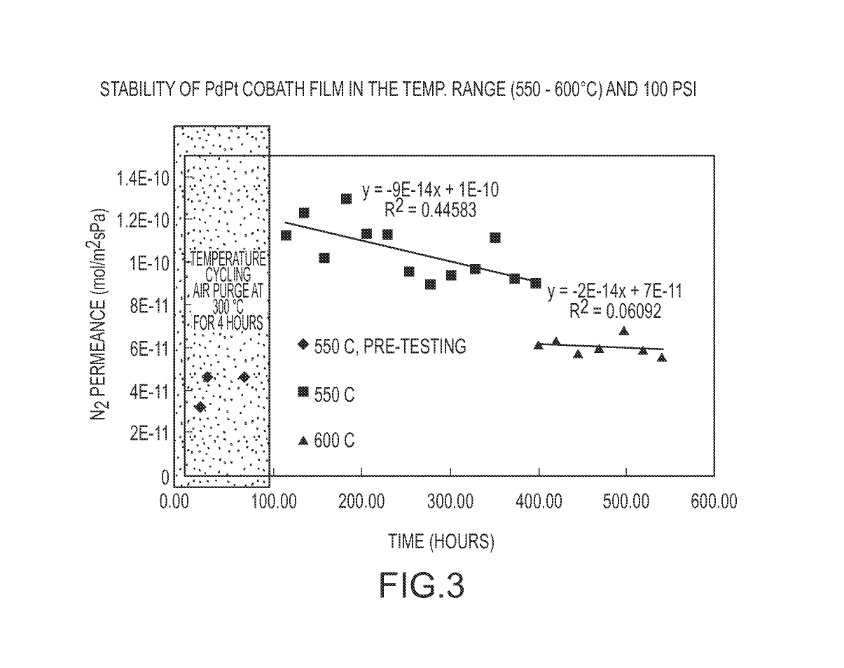

FIG. 3 depicts nitrogen leakage rate data at temperatures of about 823 (depicted with squares) and 873 degrees Kelvin (depicted with triangles) and about 100 psi differential pressure across a palladium-alloyed membrane having about 3 mass % platinum, measured by surface SEM/EDAX. The alloyed-membrane was prepared by electroless co-deposition of palladium and platinum. The nitrogen leakage rate, as expressed as permeance or flux/driving force, remains substantially stable at about 873 degrees Kelvin for over about 200 hours. These data show that palladium-alloyed with a metal having a higher melting point than palladium can substantially provide high temperature stability to the palladium-alloyed membrane.

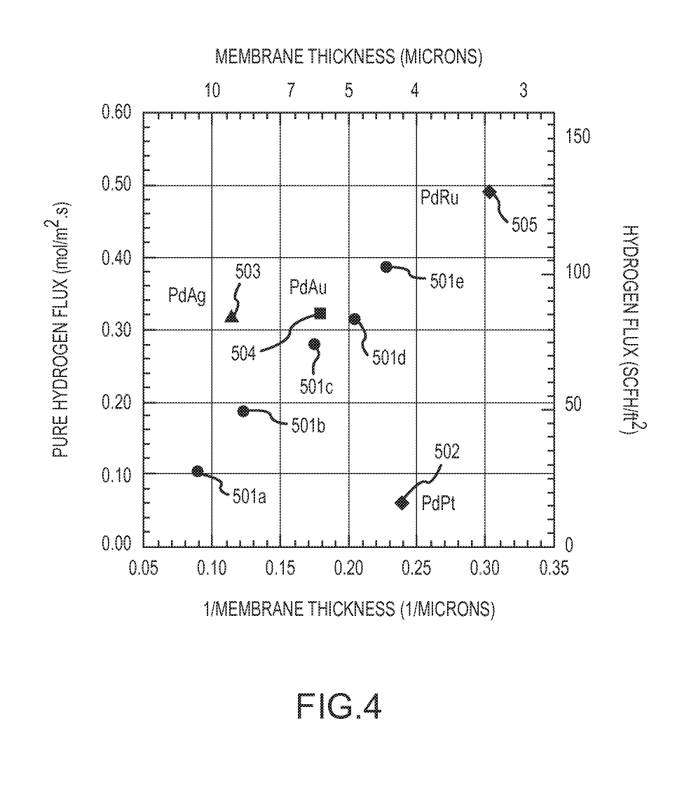

FIG. 4 depicts the influence of membrane thickness on hydrogen flux. The hydrogen flux was determined at about 670 degrees Kelvin and about 0.14 MPa (20 psi). The hydrogen flux for an unalloyed palladium membrane having thicknesses of about 4.4 microns (501e), 4.9 microns (501d), 5.7 microns (501c), 8.0 microns (501b), and 12.5 microns (501a) are depicted. The hydrogen flux for a palladium-alloyed membrane having about 31 mass % platinum (502) was substantially less, about 0.06 mol/m²·s, than an unalloyed palladium membrane, about 0.4 mol/m²·s, of similar thickness (501e). Furthermore, the hydrogen flux palladium-alloyed membranes containing silver (503), gold (504) and ruthenium (505) are depicted. The palladium-alloyed membrane having about 0.5 wt. % ruthenium (505) had a hydrogen flux of about 0.5 mol/m²·s, which corresponds to an extrapolated hydrogen flux for an unalloyed palladium membrane having a thickness of about 3.2 microns. The hydrogen flux for a palladium-alloyed membrane having about 5 wt. % gold (504) was greater, about 0.31 mol/m²·s, than an unalloyed palladium membrane, about 0.28 mol/m²·s, of similar thickness (501c). The hydrogen flux for a palladium-alloyed membrane having about 20 wt. % silver (503) was substantially greater, about 0.31 mol/m²·s, than an unalloyed palladium membrane, about 0.18 mol/m²·s, of similar thickness (501b).

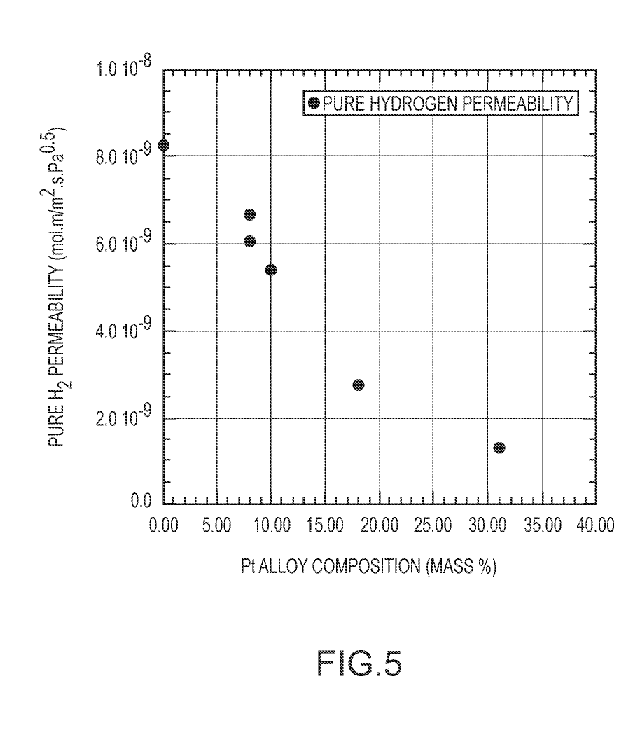

FIG. 5 depicts the influence of mass % of metal(s) alloyed with the palladium on the pure hydrogen permeability of palladium-alloyed membranes. More specifically, FIG. 5 depicts the influence of mass % platinum alloyed with palladium on the pure hydrogen permeability at about 670 degrees Kelvin. The palladium-alloyed membranes were supported on porous, zirconia membrane supports. Praxair™ provided the membrane supports. The palladium-alloyed membrane containing about 31 mass % platinum, and was made by electrolessly co-depositing of palladium and platinum layers. The palladium-alloyed membranes having about 8, 10 and 18 mass % platinum were made by sequentially electrolessly plating separate palladium and platinum layers. The unalloyed palladium membrane was made by electrolessly plating palladium. All of the membranes were annealed after depositing of the metallic layers on the membrane support. While not wanting to bound by any theory, the lower the lower the mass % of platinum alloyed with palladium the higher the pure hydrogen permeability of the palladium platinum-alloyed membrane.

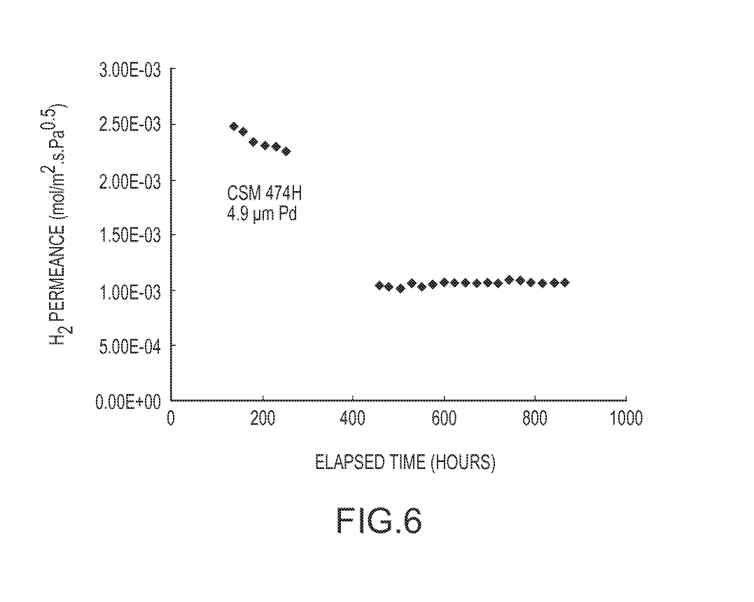

FIG. 6 depicts a comparison of molecular hydrogen (H₂) permeance stability at about 600 degrees Celsius for an unalloyed palladium membrane (CSM 747H, depicted with circles) having a thickness of about 4.9 μm to palladium-alloyed membrane having about 27 mass % platinum (CSM 498H, depicted with diamonds) and thickness of about 4.4 μm. The molecular hydrogen permeance of the unalloyed palladium membrane decreased over a period of about 100 hours. The palladium-alloyed membrane having platinum had a substantial stable hydrogen permance. More specifically, the palladium-alloyed membrane having about 27 mass % platinum had a substantial stable hydrogen permance with little, if any, decrease in molecular hydrogen permeance over more than about a period of about 400 hours.

Tables II and III depict nitrogen leakage rates and membrane compositions for various unalloyed palladium (M-54, M-34b, CSM 304 and CSM 474H) and palladium-alloyed (Prax 27-B-10, CSM 498H, CSM 493H) membranes. Membranes CS 304, CSM 474H, Prax 27-B-10, CSM 498H, and CSM 49311 were prepared according to various embodiments of the present disclosure and their hydrogen and their nitrogen leakage rates were determined at about 0.69 MPa (100 psi) and temperatures of about 773, 823 and 873 degrees Kelvin. Membranes M-5 and M-34b are prior art membranes, their leakage rates are their reported helium leakage rate divided by a factor of 2.65 assuming that nitrogen and helium permeate through the membrane mostly by the Knudsen diffusion mechanism. The data show that each of the palladium-alloyed membranes containing rhodium, platinum or ruthenium had reduced leakage rate increases, as determined by with nitrogen, in comparison to the unalloyed palladium membranes. At a temperature of about 773 degrees Kelvin and a pressure of about 100 psi, the palladium-alloyed membranes containing rhodium, platinum or ruthenium had leakage rate increases, as determined by with nitrogen, of from about 35 to about 50% of that of an unalloyed palladium membrane. Furthermore at a temperature of about 823 degrees Kelvin and a pressure of about 0.69 MPa (100 psi), the palladium-alloyed membranes containing rhodium, platinum or ruthenium had leakage rate increases, as determined by with nitrogen, from about 10 to about 60% of that of an unalloyed palladium membrane. Moreover at a temperature of about 873 degrees Kelvin and a pressure of about 0.69 MPa (100 psi), the palladium-alloyed membranes containing rhodium, platinum or ruthenium had leakage rate increases, as determined by with nitrogen, from about 5 to about 15% of that of an unalloyed palladium membrane.

The leak rate for the palladium-alloyed membranes alloyed with one of rhodium, platinum or ruthenium had nitrogen rate increases of no more than about 2×10⁻⁹ (mol/m²h²Pa)/h at about a temperature of 773 degrees Kelvin, and of no more than about 1×10⁻⁸ (mol/m²h²Pa)/h at temperatures of more than about 773 degrees Kelvin. Moreover, the leak rate for the palladium-alloyed membranes alloyed with one of rhodium, platinum or ruthenium had nitrogen had rate increases of no more than about 1×10⁻⁸ (mol/m²h²Pa)/h at temperatures of from about 823 to about 873 degrees Kelvin.

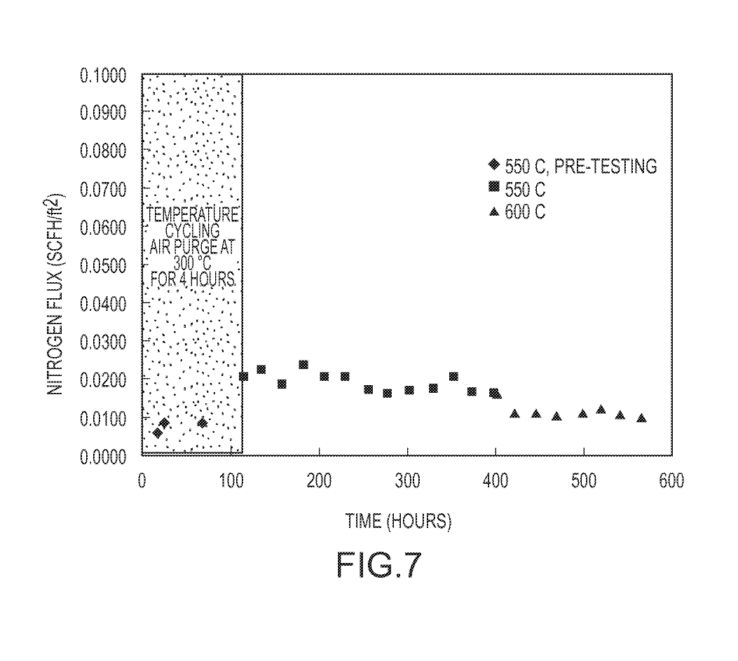

FIG. 7 depicts the influence of time and temperature on nitrogen leakage rate at 100 psig feed pressure for a 4.2 micron thick palladium-alloyed membrane having 3 mass % platinum. The palladium-alloyed membrane is supported on a porous zirconia tube. The nitrogen leakage rate at temperature of about 823 degrees Kelvin (depicted by square-shaped symbols) was substantially stable over a period of about 300 hours (over the time period from about 100 to 400 hours). Moreover, when the temperature was increased to 873 degrees Kelvin the nitrogen leakage rate (depicted by triangle-shaped symbols) remained substantially stable over a period of about 160 hours (over the time period from about 400 to about 560 hours).

These results indicate that alloying of palladium with a metal having a higher melting point than palladium such as platinum can provide long term stability of the palladium-alloyed membrane, such as the nitrogen leakage rate of the membrane at high temperatures.

One or more layers of palladium can be deposited on the membrane support and/or intermetallic layer using any suitable means or method known to those of ordinary skill in the art. Such means and methods can include electrolessly plating, thermal deposition, chemical vapor deposition, electroplating, spray deposition, sputter coating, e-beam evaporation, ion beam evaporation, magnetron sputtering and spray pyrolysis.

TABLE II

| | | | | | | | | |
|---|---|---|---|---|---|---|---|---|
| | Membrane | Alloy | | | | | | |
| | Thickness | Level | | dPN₂/dt | dPN₂/dt | dPN₂/dt | dPN₂/dt | dPN₂/dt |
| Membrane | (micron) | (wt. %) | Support | (SCFH/ft²h) | (SCFH/ft²psi) | (mol/m²hPa)/h | (mol/m²sPa)/s | (mol/m²sPa)/h |

773 K 100 psi

| | | | | | | | | |
|---|---|---|---|---|---|---|---|---|
| Prax | 4.3 | 1.1% Rh | Praxair ® | 7.0 × 10⁻⁵ | 7.0 × 10⁻⁷ | 1.4 × 10⁻⁹ | 1.1 × 10⁻¹⁶ | 3.8 × 10⁻¹³ |
| 27-B-10 | | | | | | | | |
| CSM 498H | 4.4 | 27% Pt | Pall | 8.0 × 10⁻⁵ | 8.0 × 10⁻⁷ | 1.6 × 10⁻⁹ | 1.2 × 10⁻¹⁶ | 4.4 × 10⁻¹³ |
| | | | Accusep ® | | | | | |
| CSM 497H | 6.3 | 0.1% Ru | Pall | 1.0 × 10⁻⁴ | 1.0 × 10⁻⁶ | 2.0 × 10⁻⁹ | 1.5 × 10⁻¹⁶ | 5.5 × 10⁻¹³ |
| | | | Accusep ® | | | | | |
| CSM 304 | 4.9 | Pure Pd | Pall | 2.0 × 10⁻⁴ | 2.0 × 10⁻⁶ | 4.0 × 10⁻⁹ | 3.0 × 10⁻¹⁶ | 1.1 × 10⁻¹² |
| | | | Accusep ® | | | | | |
| CSM 452 | 5 | 3% Au | Pall | 9.0 × 10⁻⁴ | 9.0 × 10⁻⁶ | 1.8 × 10⁻⁸ | 1.4 × 10⁻¹⁵ | 4.9 × 10⁻¹² |
| | | | Accusep ® | | | | | |

823 K 100 psi

| | | | | | | | | |
|---|---|---|---|---|---|---|---|---|
| Prax | 4.3 | 1.1% Rh | Praxair ® | 1.0 × 10⁻⁴ | 1.0 × 10⁻⁶ | 2.0 × 10⁻⁹ | 1.5 × 10⁻¹⁶ | 5.5 × 10⁻¹³ |
| 27-B-10 | | | | | | | | |
| CSM 498H | 4.4 | 27% Pt | Pall | 3.0 × 10⁻⁴ | 3.0 × 10⁻⁶ | 5.9 × 10⁻⁹ | 4.56 × 10⁻¹⁶ | 1.6 × 10⁻¹² |
| | | | Accusep ® | | | | | |
| CSM 493H | 6 | 0.3% Ru | Pall | 6.0 × 10⁻⁴ | 6.0 × 10⁻⁶ | 1.2 × 10⁻⁸ | 9.1 × 10⁻¹⁶ | 3.3 × 10⁻¹² |
| | | | Accusep ® | | | | | |
| CSM 474H | 4.9 | Pure Pd | Pall | 1.4 × 10⁻³ | 1.4 × 10⁻⁵ | 2.8 × 10⁻⁸ | 2.1 × 10⁻¹⁵ | 7.7 × 10⁻¹² |
| | | | Accusep ® | | | | | |
| Prax | 4.3 | 1.1% Rh | Praxair ® | 1.0 × 10⁻⁴ | 1.0 × 10⁻⁶ | 2.0 × 10⁻⁹ | 1.5 × 10⁻¹⁶ | 5.5 × 10⁻¹³ |
| 27-B-10 | | | | | | | | |
| CSM 498H | 4.4 | 27% Pt | Pall | 3.0 × 10⁻⁴ | 3.0 × 10⁻⁶ | 5.9 × 10⁻⁹ | 4.56 × 10⁻¹⁶ | 1.6 × 10⁻¹² |
| | | | Accusep ® | | | | | |
| CSM 493H | 6 | 0.3% Ru | Pall | 6.0 × 10⁻⁴ | 6.0 × 10⁻⁶ | 1.2 × 10⁻⁸ | 9.1 × 10⁻¹⁶ | 3.3 × 10⁻¹² |
| | | | Accusep ® | | | | | |
| CSM 474H | 4.9 | Pure Pd | Pall | 1.4 × 10⁻³ | 1.4 × 10⁻⁵ | 2.8 × 10⁻⁸ | 2.1 × 10⁻¹⁵ | 7.7 × 10⁻¹² |
| | | | Accusep ® | | | | | |

873 K 100 psi

| | | | | | | | | |
|---|---|---|---|---|---|---|---|---|
| Prax | 4.3 | 1.1% Rh | Praxair ® | 8.0 × 10⁻⁴ | 8.0 × 10⁻⁶ | 1.58 × 10⁻⁸ | 1.22 × 10⁻¹⁵ | 4.4 × 10⁻¹² |
| 27-B-10 | | | | | | | | |
| Prax | 4.3 | 1.1% Rh | Praxair ® | 8.0 × 10⁻⁴ | 8.0 × 10⁻⁶ | 1.58 × 10⁻⁸ | 1.22 × 10⁻¹⁵ | 4.4 × 10⁻¹² |
| 27-B-10 | | | | | | | | |
| CSM 498H | 4.4 | 27% Pt | Pall | 3.0 × 10⁻⁴ | 3.0 × 10⁻⁶ | 5.91 × 10⁻⁹ | 4.56 × 10⁻¹⁶ | 1.6 × 10⁻¹² |
| | | | Accusep ® | | | | | |
| CSM 493H | 6 | 0.3% Ru | Pall | 6.0 × 10⁻⁴ | 6.0 × 10⁻⁶ | 1.18 × 10⁻⁸ | 9.12E−¹⁶ | 3.3 × 10⁻¹² |
| | | | Accusep ® | | | | | |
| CSM 474H | 4.9 | Pure Pd | Pall | 6.4 × 10⁻³ | 6.4 × 10⁻⁵ | 1.26 × 10⁻⁷ | 9.73E⁻¹⁵ | 3.5 × 10⁻¹¹ |
| | | | Accusep ® | | | | | |

TABLE III

| | | | Total | | | |
|---|---|---|---|---|---|---|
| | | Bulk | testing | | | |
| | Thickness | composition | time at | Final H₂ | Final H₂/N₂ | |
| Membrane | (mass gain) | (mass gain) | temp. | permeance | selectivity | N₂ leak increase rate |
| ID | (μm) | (wt. %) | (hour) | (mol/m²/s/Pa^{0.5}) | (AP = 690 kPa) | (mol/m²/s/Pa)/h |
| 27-B-10 | 4.3 | Pd—1Rh | 120 | 9.9E−4 | 705 | 5.65E−13 |
| CSM 473H | 6.3 | Pd—17Pt | 116 | 1.39E−03 | 1,590 | 2.00E−12 |
| CSM 498H | 4.4 | Pd—27Pt | 147 | 8.82E−04 | 626 | 1.00E−12 |
| CSM 493H | 6.0 | Pd—Ru | 119 | 2.10E−03 | 1,860 | 3.00E−12 |
| M-54* | 4.0 | Pd | 60 | Not reported | Not | 8.54E−11* |
| | | | | | reported | |
| M-34b* | 8.0 | Pd | 160 | Not reported | Not | 2.41E−11* |
| | | | | | reported | |

*In these experiments, the membranes were supported on a porous Hastelloy (PH) substrate tube with a surface area of 120 cm². Helium was used to determine the leak evolution rate thus the helium leak rates reported by have been divided by a factor of 2.65 assuming that nitrogen and helium permeate through the membrane mostly via the Knudsen diffusion mechanism.

An electroless deposition process can be used to make the palladium-alloyed membrane. For example, the palladium-alloyed membrane can be made by electrolessly depositing palladium and an alloying metal on a support. The palladium and alloying metals can be electrolessly deposited at the same time or sequentially in any order to form one or more deposited layers on the membrane support. For example, the palladium and alloying metal(s) may be substantially electrolessly deposited in a single palladium/alloying metal layer on the membrane support. In another example, after electrolessly depositing one of the palladium or alloying metals on the membrane support, the other of the palladium or alloying metal(s) is be electrolessly deposited on the membrane support. When the palladium and alloying metal(s) are deposited sequentially in a layered manner, they may be electrolessly deposited in any order and in any number of layers. Moreover, each of the layers may independently electrolessly deposited in varying degrees of thickness. The electrolessly deposited layers may have substantially about the same thickness or may have different thicknesses. The palladium layers are typically thinner than the alloy layer(s). Moreover, the alloy layer is commonly positioned between the palladium layers. It can be appreciated that the alloying metals are be selected from the group of metals consisting essentially of silver, gold, platinum, rhodium, iridium, ruthenium and osmium.

After deposition of the palladium and alloy metals, the deposited palladium and alloy metals are heat treated, i.e., annealed, to produce the palladium-alloyed membrane. The deposited palladium and alloy metals on the membrane support are annealed at high temperature (typically from about 720 to about 970 degrees Kelvin) to form the palladium-alloyed membrane. Typically, after the high temperature annealing, the palladium and alloy metals are substantially disturbed throughout the palladium-alloyed membrane, more typically the palladium and alloy metals are substantially homogenously disturbed throughout the palladium-alloyed membrane.

Typically, the thickness of the palladium-alloyed membrane is from about 1 to about 20 microns. Moreover, palladium-alloyed membranes on a zirconia-coated stainless steel support in the form of tubes have a thickness ranging from about 0.5 to about 30 microns, more preferably from about 1 to about 20 microns.

While not wanting to be bound by any theory, it is believed that the temperature stability will correlate directly with the mass % and/or atom % of the one or more alloying metals in the palladium-alloyed membrane. That is, a higher level of thermal stability is expected for membranes having higher mass % and/or atom % of the alloying metal(s). Furthermore, it is believed that the palladium-alloyed membrane hydrogen flux value will be inversely related to mass % and/or atom % of the alloying metals in palladium-alloyed membrane. More specifically, lower levels of hydrogen flux are to be expected for palladium-alloyed membranes having greater mass % and/or atom % of the alloying metal(s).

Typically, the palladium-alloyed membrane has from about 10 to about 60 mass % and/or atom % of the one or more alloying metals, more typically from about 15 to about 50 mass % and/or atom % of the one or more alloying metals, even more typically from about 20 to about 40 mass % and/or atom % of the one or more alloying metals, yet even more typically from about 25 to about 35 mass % and/or atom % of the one or more alloying metals, or still yet even more typically about 30 mass % and/or atom % of the one or more alloying metals. Commonly, the palladium-alloyed membrane has from about 10 to about 60 mass % and/or atom % of platinum, more commonly from about 15 to about 50 mass % and/or atom % of platinum, even more commonly from about 20 to about 40 wt. % and/or atom % platinum, yet even more commonly from about 25 to about 35 mass % and/or atom % platinum, or still yet even more commonly about 30 mass % and/or atom % platinum.

Generally, the palladium-alloyed membrane has from about 5 to about 30 mass % and/or atom %, more generally from about 10 to about 25 mass % and/or atom %, or even more generally from about 15 to about 20 mass % and/or atom % of one or more of silver, gold, platinum, rhodium, iridium, ruthenium and osmium. Typically, the palladium-alloyed membrane has from about 5 to about 30 mass % and/or atom % of platinum, more generally from about 10 to about 25 mass % and/or atom % platinum, or even more generally from about 15 to about 20 mass % and/or atom % platinum. Commonly, the palladium-alloyed membrane has from about 5 to about 30 mass % and/or atom % of silver, more generally from about 10 to about 25 mass % and/or atom % of silver, or even more generally from about 15 to about 20 mass % and/or atom % of silver. Typically, the palladium-alloyed membrane has from about 5 to about 30 mass % and/or atom % of gold, more generally from about 10 to about 25 mass % and/or atom % of gold, or even more generally from about 15 to about 20 mass % and/or atom % of gold. Commonly, the palladium-alloyed membrane has from about 5 to about 30 mass % and/or atom % of rhodium, more generally from about 10 to about 25 mass % and/or atom % of rhodium, or even more generally from about 15 to about 20 mass % and/or atom % of rhodium. Typically, the palladium-alloyed membrane has from about 5 to about 30 mass % and/or atom % of ruthenium, more generally from about 10 to about 25 mass % and/or atom % of ruthenium, or even more generally from about 15 to about 20 mass % and/or atom % of ruthenium. Commonly, the palladium-alloyed membrane has from about 5 to about 30 mass % and/or atom % of iridium, more generally from about 10 to about 25 mass % and/or atom % of iridium, or even more generally from about 15 to about 20 mass % and/or atom % of iridium. Typically, the palladium-alloyed membrane has from about 5 to about 30 mass % and/or atom % of osmium, more generally from about 10 to about 25 mass % and/or atom % of osmium, or even more generally from about 15 to about 20 mass % and/or atom % of osmium.

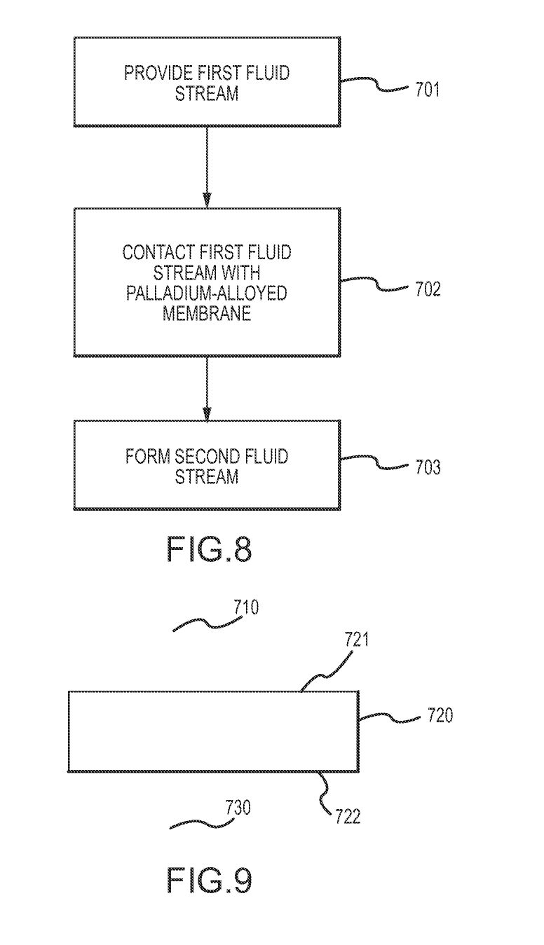

FIG. 8 depicts a method for separating molecular hydrogen from a gaseous fluid stream. The method includes (in step 701) providing a first gaseous fluid stream 710 having a first volume % of molecular hydrogen (H₂) and one or more of a hydrocarbon compound, water, carbon dioxide, and carbon monoxide, and contacting (in step 702) a palladium-alloyed membrane 720 from about 95 mass % to about 70 mass % palladium and from about 5 mass % to about 30 mass % of an alloying metal with the first gaseous fluid stream to form (step 703) a second gaseous fluid stream 730 having a second volume % of molecular hydrogen, the second volume % of hydrogen being greater than the first volume % of hydrogen. The palladium-alloyed membrane 720 commonly has opposing first 721 and second 722 membrane sides (as shown in FIG. 9). The first gaseous fluid stream 720 is typically adjacent to and/or in contact with the first membrane side 721 and the second gaseous fluid stream 730 is typically adjacent to and/or in contact with the second membrane side 722. Preferably, the palladium-alloyed membrane 720 has an average thickness of from about 1 to about 10 μm and a nitrogen leakage growth rate at about 823 degrees Kelvin or more of no more than about 7×10⁻¹² (mol/m²/s/Pa)/h. The palladium-alloyed membrane 720 typically comprises palladium and one or more of ruthenium, platinum, silver, gold and osmium. Moreover, the palladium-alloyed membrane 720 can have a hydrogen permeance of from about 1×10⁻³ to about 1×10⁻² mol/m²/s/Pa^{0.5}. Furthermore, the palladium-alloyed membrane 720 can comprise palladium and one of about 0.5 wt. % ruthenium, no more than about 1 mass % ruthenium, about 17 wt. % platinum, and about 27 wt. % platinum.

Typically, the first gaseous fluid stream 710 has a first hydrocarbon compound volume % and the second gaseous fluid stream 730 has a second hydrocarbon compound volume % of no more than about 1% of the first hydrocarbon compound volume %. Commonly, the first gaseous fluid stream 720 has a first water volume % and the second gaseous fluid stream 730 has a second water volume % of no more than about 1% of the first water volume %. Generally, the gaseous first fluid stream 720 has a first carbon dioxide volume % and the second gaseous fluid stream 730 has a second carbon dioxide volume % of no more than about 1% of the first carbon dioxide volume %. More typically, the first gaseous fluid stream 720 has a first carbon monoxide volume % and the second gaseous fluid stream 730 has a second carbon monoxide volume % of no more than about 1% of the first carbon monoxide volume %.

Metal membranes offer a significant process simplification and energy reduction for separating hydrogen and carbon dioxide during steam reforming of methane and/or other hydrocarbons. By continuously removing hydrogen during the stream reforming process, the steam reforming reactions can be driven to a higher level of completion. Moreover, a more highly concentrated hydrogen stream can be formed by the continuous removal of hydrogen during the reforming process. Furthermore, the hydrogen stream can have a higher level of purity than what is typically achieved during steam reforming. A more highly pressurized carbon dioxide stream can also be produced by the continual removal of hydrogen.

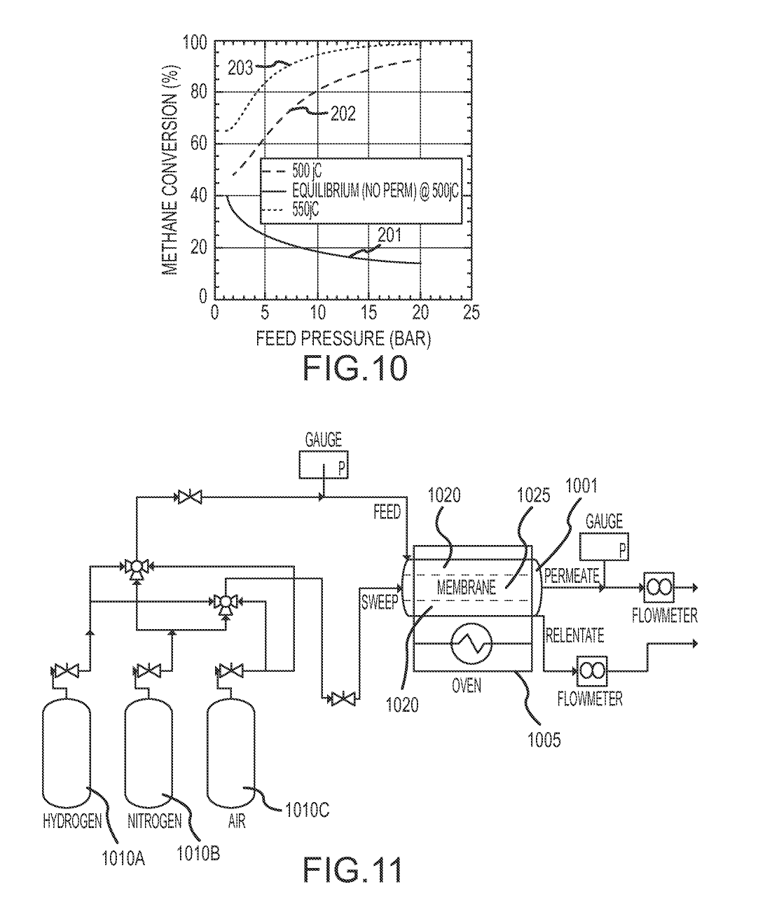

FIG. 10 depicts calculated percent methane conversion values for a conventional, equilibrium steam reforming reactor at 500 degrees Celsius (line 201) and for a membrane reactor (lines 202 and 203) using a palladium-alloyed membrane at temperatures of 500 and 550 degrees Celsius and a molar ratio of water to methane of three. The conventional, equilibrium steam reforming reactor calculation did not include in-situ hydrogen separation, while the membrane reactor calculations included in-situ hydrogen separation.

The maximum calculated percent conversion for a conventional, equilibrium steam reforming reactor was about 40% at 1 bar differential pressure and 500 degrees Celsius. Furthermore, in a conventional, equilibrium steam reforming reactor the percent conversion level decreases with increasing reactor pressure. For example, the percent conversion decreased from a high of about 40% at about 1 bar to low of about 15% at about 20 bars at 500 degrees Celsius.

This is in contrast to the percent conversion achieved when hydrogen gas is removed during stream reforming. Lines 202 and 203 depict the conversion levels when hydrogen gas is removed during steam reforming. The conversion levels are substantially greater when hydrogen is removed during the steam reforming process. In a membrane reactor where the membrane removes the formed hydrogen gas during steam reforming the conversion levels are greater than about 45%. Typically, the maximum level of methane conversion in a membrane reactor can be from about 45 to about 65% at low pressures and from about 90 to about 100% at higher reactor pressures. For the membrane process the level of methane conversion increases with increases in the reactor feed pressure (lines 202 and 203). This is in contrast to conventional steam reforming reactors where the level of methane conversion decreases with increases in the reactor feed pressure (line 201).

Typically, for a membrane reactor, the methane conversion level increases with increases in the membrane reactor operating temperature. By way of example only, the methane conversation level increases by about 20% at low feed pressures of less than about 10 bars and an increase of the operating temperature from about 500 to about 550 degrees Celsius. At feed pressures of more than about 10 bars and an increase of the operating temperature from about 500 to about 550 degrees Celsius increases the methane conversation level by about 5 to about 15%.

Commonly, a membrane reactor at a feed pressure of about 25 bar (365 psi) or less and at an operating temperature of no more than 600 degrees Celsius has a methane conversion level of about 90%, more commonly of about 95%, yet even more commonly of about 99%, or still yet even more commonly of substantially about 100%. Typically, a membrane reactor at a feed pressure of about 25 bar (365 psi) or less and an operating temperature of no more than about 600 degrees Celsius has a methane conversion level of more than 90%, more typically of more than 95%, yet even more typically of more than about 99%, or still yet even more typically substantially about 100%.

Commonly, a membrane reactor at a feed pressure of about 20 bar (300 psi) or less and an operating an temperature from about 500 to about 550 degrees Celsius has a methane conversion level of about 90%, more commonly of about 95%, yet even more commonly of about 99%, or still yet even more commonly substantially about 100%. Typically, a membrane reactor at a feed pressure of about 20 bar (300 psi) or less and an operating temperature of about 550 degrees Celsius or less has a methane conversion level of more than about 90%, more typically of more than about 95%, yet even more typically of more than about 99%, or still yet even more typically substantially about 100%.

Up to about a 50% reduction in one or both of operating (energy and raw material costs to name a few) and capital (reactors, vessels, piping and so forth) costs can be achieved with a reduction in the operating temperature from about 550 to about 1,000 degrees Celsius.

### EXAMPLES

The following examples are provided to further illustrate the disclosure, but are not to be construed as limiting the scope of the disclosure.

### Membrane Supports

Tubular, asymmetric AccuSep® membrane supports were purchased from the Pall Corporation. The membrane supports were porous stainless steel coated with about a 30 thick layer of porous yttria-stabilized zirconia. The pure palladium or palladium-alloyed films were deposited by electroless plating on the membrane supports. The supports had an active length of about 5 cm, an outer diameter of about 1 cm, and a mean pore diameter of about 0.07 μm. The yttria-stabilized zirconia layer can reduce surface roughness of the support. Furthermore, it is believed that metallic interdiffusion between the palladium-alloyed film and the porous stainless steel substrate during operation at high temperatures (such as without limitation, temperatures of about 670 degrees Kelvin or greater) can be reduced by the yttria-stabilized zirconia. The 30 μm thick yttria-stabilized zirconia layer had a porosity of about 30%.

Regarding Accusep® membrane support tubes, Accusep® tubes have a coated, porous part that transitioned to nonporous stainless steel tubing having a diameter of about 1 cm. The tubes Accusep® can be hermetically connected to other tubing by standard stainless steel compression fittings or welding.

### Support Cleaning and Characterization

Prior to depositing any metal onto the membrane support, the as-received membrane supports were thoroughly cleaned by successive immersion in acetone and hydrogen peroxide solutions, rinsed in deionized water, then dried overnight at about 405 K in air. Pore size distribution of the membrane support was determined by flow porometry methods known to persons of ordinary skill in the art.

### Membrane Synthesis

The palladium-alloyed membranes were fabricated by electroless plating methods. Metal ions, such as without limitation one or more of palladium, ruthenium, platinum, rhodium, osmium, iridium, silver, gold, copper cations and mixtures thereof, were electrolessly deposited as neutral metal atoms on an activated membrane support. The electroless plating bath recipes used in this sturdy are shown in Table IV. The plating solution volume to membrane surface area ratio was kept constant at about 3.3.

An activated membrane support typically contains palladium nucleation sites. The following process was used to form the palladium nucleation sites on one or more membrane support surfaces. One or more surfaces of the membrane support were coated with a chloroform solution of palladium acetate. The palladium acetate coating was formed by spraying, typically with an air brush sprayer system, the one or more membrane support surfaces. After forming a substantially uniform coating of palladium acetate on the one or more membrane support surfaces, the palladium acetate-coated support was fired at a temperature greater than the decomposition temperature of the palladium acetate. Palladium acetate typically decomposes at temperature of about 620 degrees Kelvin or greater. The palladium acetate-coated support was fired for about 5 hours in air at a temperature of about 620 degrees Kelvin or more. The firing process decomposes the acetate portion of the palladium acetate and forms a layer of nanocrystalline palladium oxide on the one or more support surfaces. Nano-crystals of palladium are formed on the one or more membrane support surfaces by contacting a basic dilute hydrazine solution with the noncrystalline palladium oxide. These palladium nanocrystals can act as catalytic nucleation sites during electroless plating of the metallic ions on the membrane support.

The metallic ions can be either electrolessly co-deposited or sequentially electrolessly deposited. Table IV provides data for palladium, platinum and rhodium electroless deposition baths and for co-deposition electroless baths for palladium platinum co-deposition, palladium ruthenium co-deposition, and palladium rhodium co-deposition. Multiple electrolessly deposited layers were formed by sequentially repeating the co-deposition and sequential deposition of the metallic ions. Various compositions of the palladium-alloyed membranes were fabricated by sequentially repeating the electroless deposition process. After the electroless deposition of the metallic ions, the electrolessly deposited layers were annealed to form the palladium-alloyed membrane. After the annealing process, the metallic ions contained in the electrolessly layers are typically distributed throughout the palladium-alloyed membrane.

Table V contains a summary of some of the membranes fabricated and tested. Two unalloyed palladium membranes (CSM 304 and CSM 47411) were fabricated as controls and tested at temperatures up to about 873 degrees Kelvin. Two palladium-alloyed membranes having palladium and 17 wt. % platinum (CSM 473H) and 27 wt. % platinum (CSM 498H) were prepared by alternating electrolessly depositing layers of palladium and platinum. Furthermore, one palladium-alloyed membrane containing palladium and ruthenium (CSM 493H) was fabricated by electroless co-deposition of palladium and ruthenium. The thicknesses and compositions of the membranes were determined gravimetrically. The membranes had a thickness of about 5 μm±1 μm. Furthermore, the membranes had a room temperature nitrogen leakage permeance of no more than about 7.19×10⁻¹² mol/m²/s/Pa.

TABLE IV

| | | | Palladium | | Palladium | Palladium |
|---|---|---|---|---|---|---|
| | | | Platinum | | Ruthenium | Rhodium |
| | Palladium | Platinum | Co-Deposition | Rhodium | Co-Deposition | Co-Deposition |
| Component | Bath | Bath | Bath | Bath | Bath | Bath |
| Deionized Water | 599 mL/L | 990 mL/L | 599 mL/L | 665 mL/L | 679 mL/L | 679 mL/L |
| Ammonium Hydroxide | 390 mL/L | 10 mL/L | 390 mL/L | 315 mL/L | 312 mL/L | 312 mL/L |
| (28-30 wt. %) | | | | | | |
| Hydrochloric Acid | 11 mL/L | — | 11 mL/L | 20 mL/L | 9 mL/L | 9 mL/L |
| (37 wt %) | | | | | | |
| Palladium(II) Chloride | 5.4 g/L | — | 0.545 g/L | — | 4.4 g/L | 4.4 g/L |
| (99% pure) | | | | | | |
| Diammine Platinum Solution | — | 7.5 g/L | 0.065 g/L | — | — | — |
| (5 wt. % Platinum) | | | | | | |
| Ruthenium(III) Chloride | — | — | — | — | 03 g/L | — |
| Rhodium(III) Chloride | — | — | — | 0.4 g/L | | 0.4 g/L |
| Hydrazine (1M) | 10 mL/L | 10 mL/L | — | 10 mL/L | 10 mL/L | 10 mL/L |
| Temperature | 50 | 60 | 50 | 60 | 70 | 55 |
| (degrees Celsius) | | | | | | |
| Duration | 30 | 30 | — | 60 | 30 | 30 |
| (minutes) | | | | | | |

### Membrane Testing

Palladium-alloyed membranes with a nitrogen gas permeance of less than about 7.2×10⁻¹⁰ mol/m²/s/Pa were mounted in compression fittings with stainless steel ferrules and installed in a testing module 1001 as depicted in FIG. 11. The testing module 1001 is centered inside an electric tube oven 1005 to control the temperature. The feed gases hydrogen gas1010A, nitrogen gas 1010B and air 1010C enter through the shell side 1020 and the hydrogen permeates through the membrane to the tube side 1025.

### Permeation Characterization

Pure gas permeation and flux determinations were made for the various pure palladium and palladium-alloyed membranes. Temperature and pressure cycling was used when making the determinations. Furthermore, hydrogen and nitrogen feed streams were alternated during the determinations. Gas permeation and flux were determined at temperatures ranging from about 670 to about 875 degrees Kevin and feed pressures from about 135 to about 690 kPa. Moreover, the permeate side (tube side 1025) was kept open to atmospheric pressure (about 83 kPa in Golden, Colo.). Aft the completing the pure gas permeation and flux determinations the pure palladium and palladium-alloyed membranes were annealed in situ under flowing hydrogen at about 823 degrees Kelvin for about 2 hours to promote metallic interdiffusion to a palladium alloy.

### Long-Term Thermal Stability Testing

The evolution of hydrogen flux and nitrogen leakage was monitored over time at a temperature ranging from about 670 to about 875 degrees Kelvin. The nitrogen leakage rate was typically measured with a pure nitrogen feed daily. Other than when the nitrogen leakage rate was being determine the membrane was under hydrogen at a pressure differential, between the shell 1020 and tube 1025 sides of about 50 kPa.

### Membrane Characterization

Thickness, composition, morphology and microstructure determinations of the pure palladium and palladium-alloyed membranes were made. Scanning electron microscopy/energy dispersive X-ray spectroscopy was conducted on surfaces and cross sections of the membranes to further characterize the membranes.

TABLE V
Summary of the Membranes Fabricated

| | | Thickness | | Bulk composition | | | Surface | | |
|---|---|---|---|---|---|---|---|---|---|
| | | in (μm) | | (wt. %) | | | composition | Testing | Total |
| | Surface | Mass | | Mass | | ICP- | by EDS | temperature | testing time |
| Membrane ID | Area (cm²) | Gain | XRF | Gain | XRF | AES | (wt %) | range (° K) | (hours) |
| CSM 304 | 14.74 | 4.9 | 5.1 | Pd | — | — | — | 773 | 141 |
| CSM 474H | 13.04 | 4.9 | 4.7 | Pd | — | — | — | 823-873 | 256 |
| CSM 473H | 12.71 | 6.3 | 6-4 | Pd—17Pt | 16 | 19 | 19 | 773-873 | 339 |
| CSM 498H | 13.88 | 4.4 | 3.9 | Pd—27Pt | 31 | 28 | 30 | 773-873 | 867 |
| CSM 493H | 13.08 | 6.0^{a} | 6.0 | Pd—Ru | <3^{b} | 0.3 | 0.6 | 773-873 | 435 |

^{a}Palladium and ruthenium were co-deposited, therefore composition by mass gain cannot be determined ICP-AES was used to determine the composition of the membrane, which was found to be 0.3 wt. %. The density was used to estimate the thickness of the palladium-ruthenium membrane gravimetrically.
^{b}The minimum detection limit of the XRF was about 3 wt. % ruthenium (by using palladium-ruthenium ally control samples with known compositions when the instrument was calibrated). Surface EDS is also not a very accurate technique for determining the ruthenium composition in palladium-ruthenium films (due overlap of the intensity peaks). ICP-AES is believed to be the most reliable method for ruthenium wt. % determination of the above.

Membrane surfaces and cross-sections were imaged in a secondary electron mode at accelerating voltages of 5-30 kV. Backscattered electron images were obtained on selected samples. Some membranes were imaged while attached to the tubular support whilesome membranes were removed from the tubular support to avoid problems with focusing on a curved surface. Furthermore, some membranes were sectioned for imaging using a diamond saw, mounted in epoxy, and polished using an automatic grinding and polishing system.

Some membranes were analyzed by energy dispersive X-ray spectroscopy. Estimations of the membrane composition were made typically by averaging at least five different energy dispersive X-ray spectroscopy surface and cross-section line scans. Voltage of a typical energy dispersive X-ray spectroscopy scan was about 20 keV.

Bulk compositional analysis of the membranes and membrane thickness were determined using X-ray fluorescence spectroscopy.

Membrane compositions were also determined by inductively coupled plasma atomic emission spectrometry. About 3 to about 20 mg piece of a membrane was dissolved in 50 wt. % aqua regia solution for quantification of metallic components of the membrane by inductively coupled plasma atomic emission spectrometry.

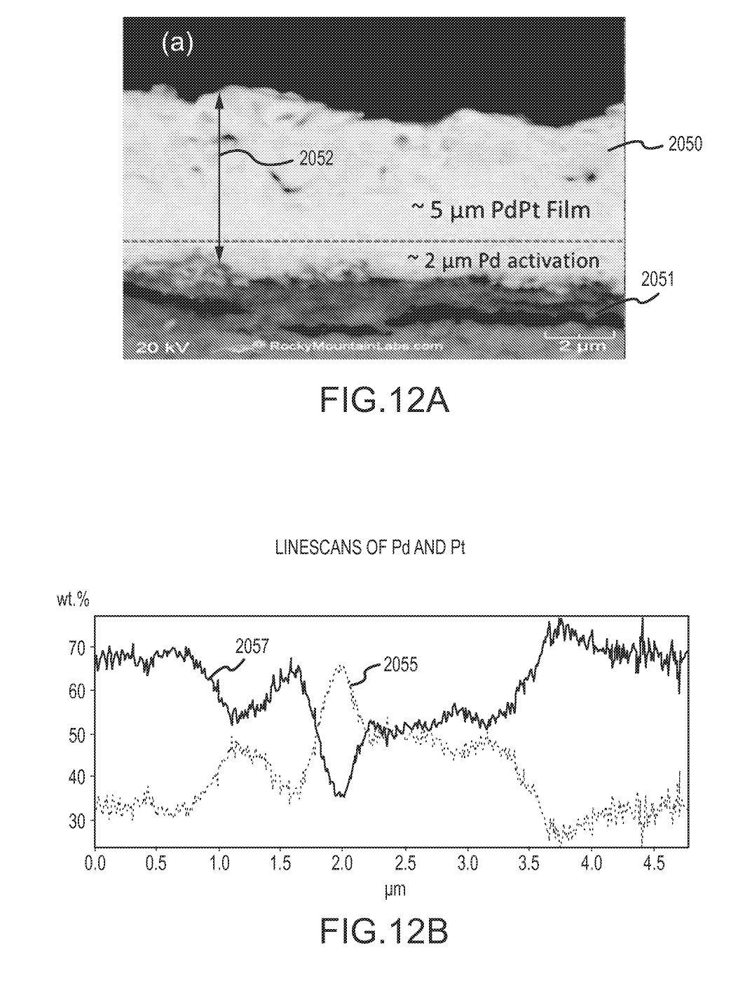

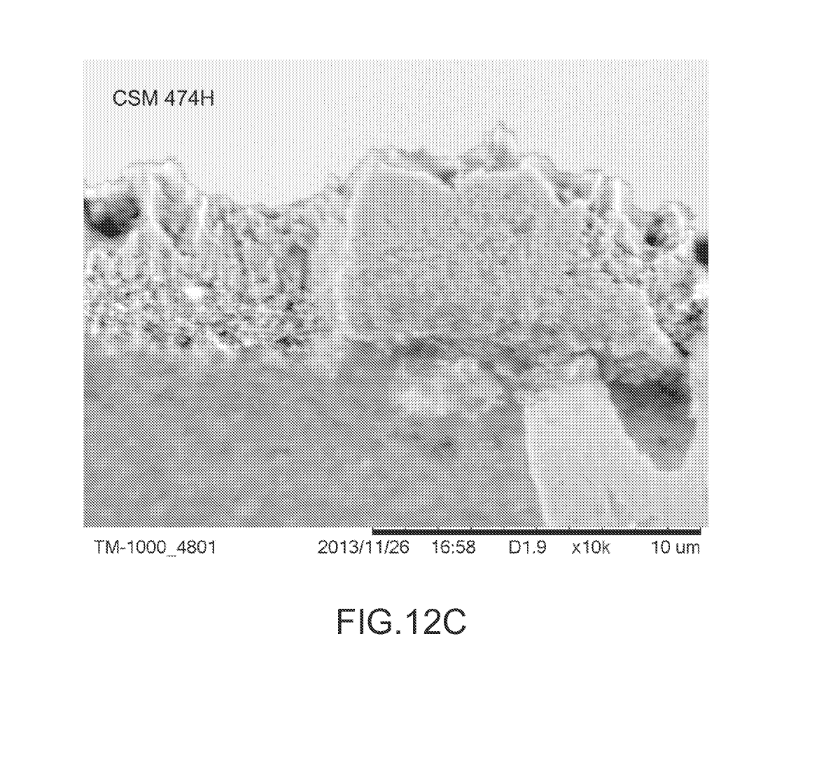

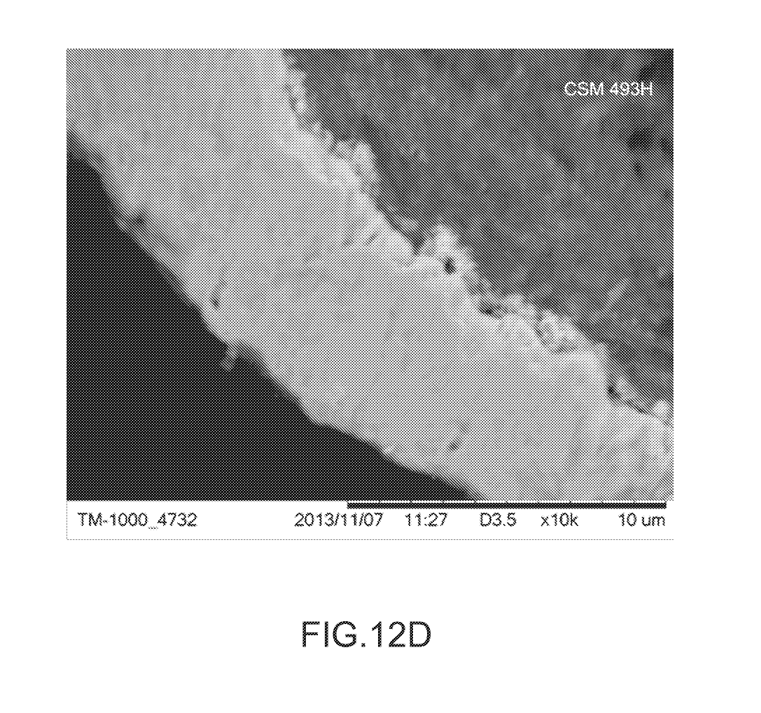

FIG. 12A shows a cross sectional scanning electron microscopy image in a backed-scattered electron mode for the 4.4 μm thick palladium-alloyed membrane having 27 wt. % platinum (CSM 498H). The apparent thickness 2050 as determined by the scanning electron microscopy image of the CSM 498H is almost twice that determined by mass gain (Table V). This was attributed to the presence of the non-dense activation layer deposited (2051 in FIG. 12A) as described above. The activation layer 2051 thickness was determined by mass gain after metal deposition assuming a dense structure was formed which turns out not to be the case. In order to get a more accurate measure of the thicknesses of the palladium-platinum layer 2052 and activation layer 2051, a piece of the palladium-platinum membrane was peeled off from the support and the palladium-platinum layer thickness 2052 as well as the platinum distribution were determined for that fractured piece. The palladium-platinum thickness 2052 was in better agreement to the thickness determined by mass gain after plating and by X-ray fluorescence. The thickness of the fracture piece depicted in FIG. 12A is about 5 μm (c.f. 4.4 μm by mass gain after plating). The platinum concentration profile (as shown in FIG. 12B) shows high levels of platinum of about 70 wt. % platinum, depicted by scan line 2055, at about the center of the film at about 2.0 μm. The palladium concentration profile is depicted by scan line 2057. The platinum layer thickness determined by mass gain during synthesis was about 0.7 μm. Moreover during the synthesis, the 0.7 μm thick platinum layer was “sandwiched” between two palladium layers. The elemental profiling depicted in FIG. 12B may indicate that the palladium-platinum sandwiched layers might not be completely annealed. However, the X-ray fluorescence (Table V), hydrogen flux stability at 873 K (FIG. 6) and the experimental activation energy are indicative of annealing.

Similar scanning electron microscopy analyses were performed on the second unalloyed palladium membrane control (CSM 474H) and the palladium-alloyed membrane having about 0.3 wt. % ruthenium (CSM 49311). Cross sectional images for fractured (peeled off) pieces are shown in FIGS. 12C and 12D, respectively. The thicknesses of the second alloyed palladium membrane control (CSM 474H) and the palladium-alloyed membrane having about 0.3 wt. % ruthenium (CSM 493H) are in good agreement with those determined gravimetrically and by X-ray fluorescence (Table V).

### Pure-Gas Permeation Characterization

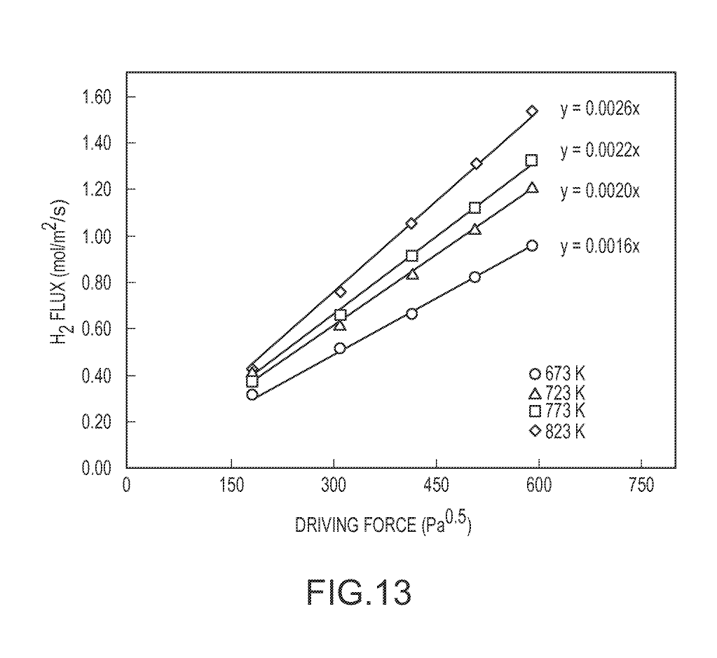

FIG. 13 shows hydrogen gas permeation flux (in units of mol/m²/s) versus driving force (Pa^{0.5}) at four different temperatures 673, 723, 773 and 823 degrees Kelvin for a 4.9 μm thick, unalloyed palladium membrane (CSM 304). The permeance is the slope of the fitted linear function at a given temperature. It can be appreciated that permeance is a measure of the membrane's performance for a specific set of conditions. Such a permeation characterization was conducted for all of the membranes listed in Table 2.

### Long-Term Thermal Stability Studies

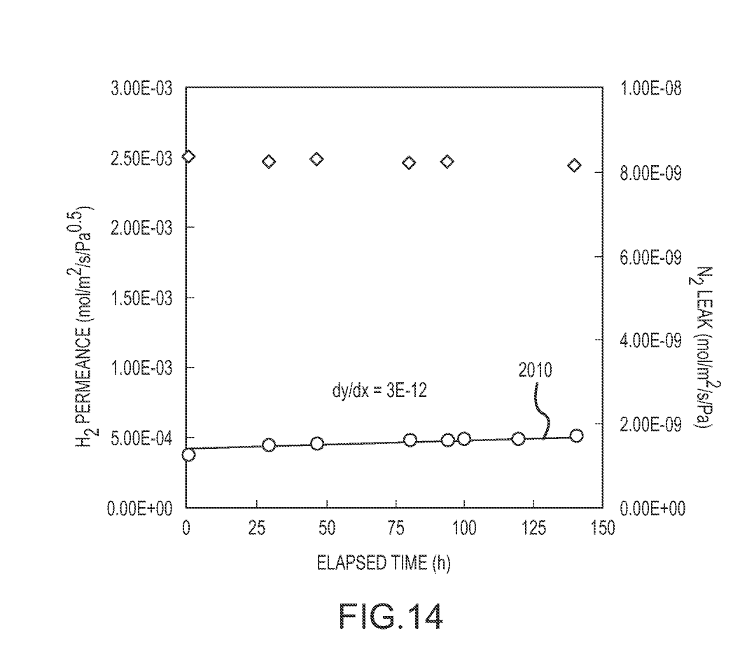

The controls for the palladium-alloyed membrane performance determinations were unalloyed palladium membranes with a thickness of 4.9 μm (CSM 304, CSM 474H). The long-term permeance data for a first unalloyed palladium membrane control (CSM 304) at a temperature of 773 degrees K are shown in FIG. 14. The hydrogen permeance (depicted by diamonds and left-hand ordinate) was substantially stable at about 2.50×10⁻³ mol/m²/s/Pa^{0.5}. Furthermore, the first unalloyed palladium control had a slowly increasing nitrogen leakage (depicted by circles and right-hand ordinate). The positive slope of line 2010 depicts the increasing nitrogen leakage growth rate of the first unalloyed palladium membrane control (CSM 304). The slope of line 2010, or nitrogen leakage growth rate, is about 3×10⁻¹² (mole/m²/s/Pa)/h. The nitrogen leakage growth rate of the first unalloyed palladium membrane control CSM 304 was lower by at least a factor of ten compared to unalloyed palladium membranes of the prior art (measured as helium leak growth rate). The is believed to one or both of test gas (helium versus nitrogen, the helium leak growth rates should be divided by a factor of 2.65 assuming that both nitrogen and helium permeate through defects in the palladium membrane mostly by the Knudsen diffusion mechanism) and differences in the synthesis of the unalloyed palladium membrane (such as using a tin-free support activation procedure; tin a low melting point, 505 degrees Kelvin, which is lower than the typical operating temperatures of unalloyed palladium membranes). The first unalloyed palladium membrane control (CSM 304 control) was damaged in a power outage that occurred at about 104 hours of testing at about 773 degrees Kelvin.

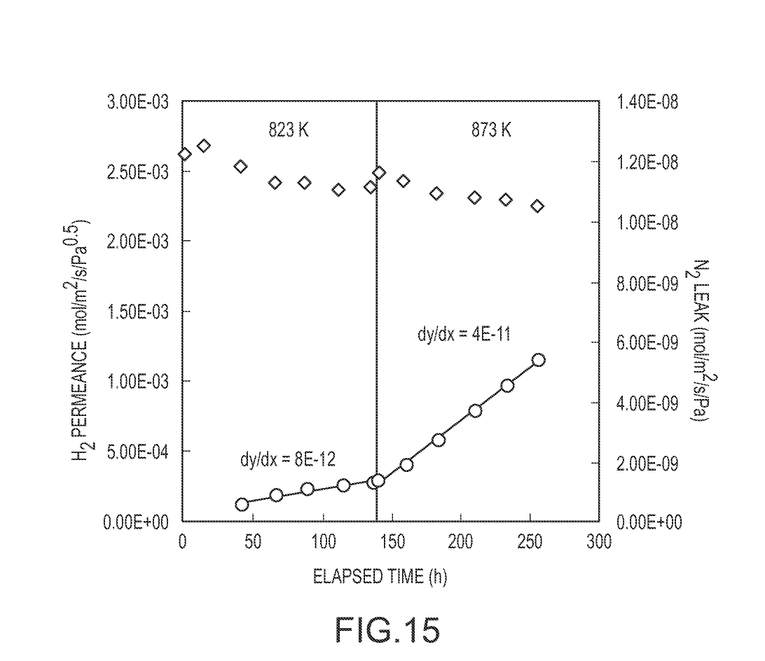

A second 4.9 μm thick unalloyed palladium control (CSM 474H) was fabricated and tested. The long-term permeance data for the second unalloyed palladium membrane control (CSM 474H) was determined temperatures of 823 and 873 degrees K are shown in FIG. 15. The hydrogen permeance (depicted by diamonds and left-hand ordinate) decreased with time and temperature, having an initial value at zero-lapsed hours and a temperature of about 823 degrees Kelvin of about 2.65×10⁻³ mol/m²/s/Pa^{0.5} and of about 2.25×10⁻³ mol/m²/s/Pa^{0.5} (depicted with diamonds, left-hand ordinate) at about 250 hours and a temperature of about 873 degrees Kelvin. Furthermore, the second pure palladium control had a slowly increasing nitrogen leakage (depicted with circles, right-hand ordinate). The hydrogen permeance declined with time and increases in temperature, The nitrogen leakage growth rate for the unalloyed palladium membrane at a temperature below about 873 degrees Kelvin was about 8×10⁻¹² (mole/m²/s/Pa)/h. However, the nitrogen leakage growth rate for at temperatures of 873 degrees or more was 4×10⁻¹¹ (mole/m²/s/Pa)/h, substantially indicative of increase of one or both of porosity and permeability of the unalloyed palladium membrane.

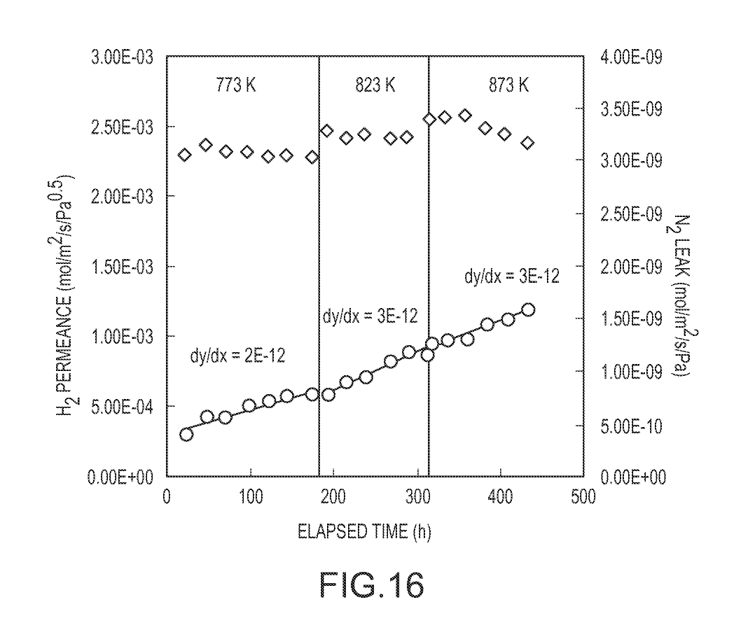

Permeance data for the palladium-alloyed membrane having about 0.3 wt. % ruthenium (CSM 493H) are shown in FIG. 16. The hydrogen permeation flux for the CSM 493H membrane substantially follows that of the first and second unalloyed palladium membrane controls (CSM 304 and CSM 47411). The palladium-alloyed membrane having about 0.3 wt. % ruthenium (CSM 493H) has almost the same hydrogen permeation flux value as the first and second controls (CSM 304 and CSM 474H) at about 2.25×10⁻³ to about 2.5×10⁻³ mol/m²/s/Pa^{0.5}. However, hydrogen permeation flux appears to start to decline at temperatures of 823 degrees K and above.

The nitrogen leakage growth rate for the CSM 493H membrane is slightly smaller, 2×10⁻¹² (mole/m²/s/Pa)/h for CSM 493H compared to 3×10⁻¹² (mole/m²/s/Pa)/h for CSM 304, at temperatures below 823 degrees Kelvin. However, the palladium-alloyed membrane having about 0.3 wt. % ruthenium (CSM 493H) had a substantially smaller nitrogen leakage growth rate compared to the second unalloyed palladium control at temperatures greater than about 823 degrees Kelvin. The nitrogen leakage growth rate of the palladium-alloyed membrane having about 0.3 wt.% ruthenium (CSM 49314) compared to the unalloyed palladium controls at temperatures greater than about 823 degrees Kelvin were more than about a factor of ten smaller than the unalloyed palladium controls. At temperatures of more than about 823 degrees Kelvin the unalloyed palladium control had nitrogen leakage growth rate of about 4×10⁻¹¹ (mole/m²/s/Pa)/h compared to the nitrogen leakage growth rate of the palladium-alloyed membrane having about 0.3 wt. % ruthenium (CSM 49311) of about 3×10⁻¹² (mole/m²/s/Pa)/h. The results suggest that adding less than about 1 wt. % of ruthenium to a palladium-alloyed metal can substantially improve the thermal stability of the membrane by lowering the leak evolution rate.

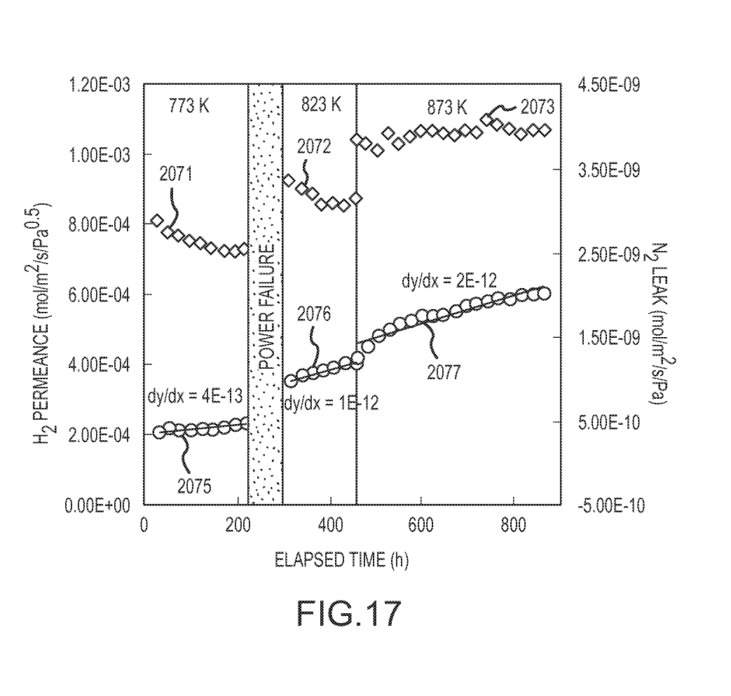

Permeance data for the palladium-alloyed membrane having about 27 wt. % platinum (CSM 498H) are shown in FIG. 17. The palladium-alloyed membranes containing platinum behaved differently than the palladium-alloyed membranes containing ruthenium. A 4.4 μm thick palladium-alloyed membrane having 27 wt. % platinum (CSM 498H) was synthesized and tested in a similar fashion to the unalloyed palladium control membranes and palladium-alloyed with ruthenium membrane. The palladium-alloyed membrane having 27 wt. % platinum (CSM 498H) was tested for more than 850 hours in flowing hydrogen at temperatures range from about 773 to about 873 degrees Kelvin. Long-term permeance testing results, after annealing for 2 hours at about 823 degrees Kelvin, are shown in FIG. 17. After annealing, the palladium-alloyed membrane (CSM 498H) was brought to a temperature of about 773 degrees Kelvin. The hydrogen permeance, after reaching the testing temperature of about 773 degrees Kelvin declined (see line 2071). While not wanting to be bound by theory, the decline in hydrogen permeance was thought to be due to metallic interdiffusion between the palladium and platinum layers that were sequentially deposited by electroless plating. The hydrogen solubility in platinum is much less than that in unalloyed palladium, which could explain the initial flux decline at about 773 degrees Kelvin. However, upon increasing the temperature to about 823 degrees Kelvin, the same trend of declining hydrogen permeance was observed for a short duration (see line 2072). This behavior is believed to indicate that the initial annealing was not sufficient to produce a homogeneous structure as evidenced by the decreasing hydrogen flux in the 773 to 823 degree Kelvin temperature range. However, upon increasing the temperature to about 873 degrees Kelvin, the hydrogen permeance was stable for more than 400 hours (line 2073). Upon shutting down the experiment, the palladium-alloyed membrane (CSM 498H) was thermally cycled down in hydrogen and nitrogen leakage growth rate data were collected at different temperatures, including temperatures as low as about 673 degrees Kelvin (not depicted in FIG. 17). This allowed for the calculation of the experimental activation energy (Eₐ) for the hydrogen permeation through the palladium-alloyed membrane (CSM 498H). The activation energy (Eₐ) for hydrogen permeation was experimentally determined to be about 30.8 kJ/mol. This suggests adequate annealing of the palladium-alloyed membrane (CSM 498H) upon heating up to about 873 degrees Kelvin and is also consistent with the surface EDS result shown in Table V. The nitrogen leakage growth rate of the palladium-alloyed membrane (CSM 498H) was almost one order of magnitude lower with values of about 4×10⁻¹³ (mole/m²/s/Pa)/h at temperatures of about 773 degrees Kelvin (line 2075), of about 1×10⁻¹² (mole/m²/s/Pa)/h at temperatures of about 823 degrees Kelvin (line 2076) and of about 2×10⁻¹² (mole/m²/s/Pa)/h at temperatures of about 873 degrees Kelvin (line 2077) than those of the unalloyed palladium membranes with values of about 8×10⁻¹² (mole/m²/s/Pa)/h at temperatures of about 823 degrees Kelvin (as shown in FIG. 15) and of about 4×10⁻¹¹ (mole/m²/s/Pa)/h at temperatures of about 873 degrees Kelvin (as shown in FIG. 15). The reduced leakage growth rates for the palladium-alloyed membrane (CSM 498H) at high temperatures, such as temperatures greater than about 773 degrees Kelvin, can make the palladium-alloyed membranes disclosed herein more suitable for high temperature applications than unalloyed palladium and/or palladium-alloyed with materials having a melting temperature about equal to or less than palladium.

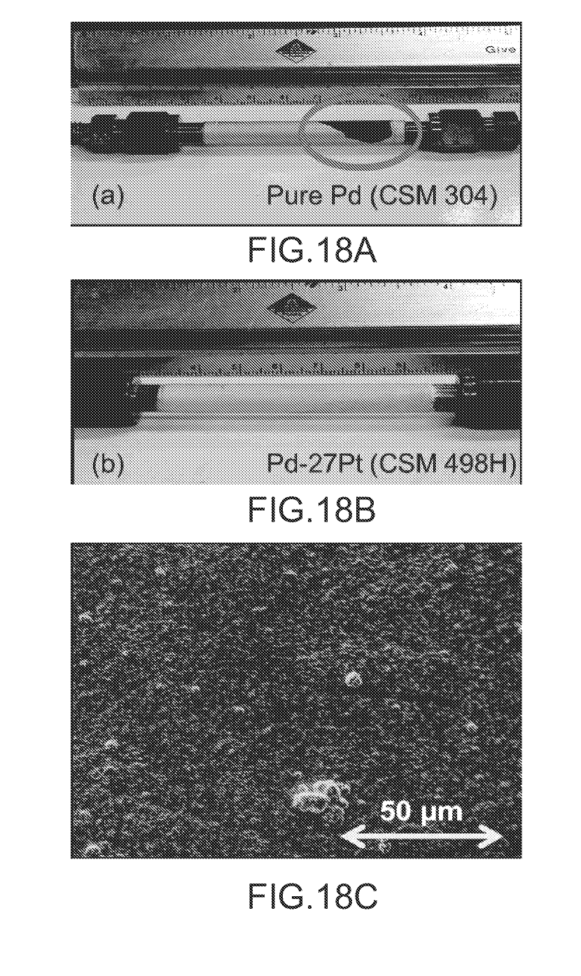

Further regarding FIG. 17, a power outage caused the membrane to be quenched in hydrogen from about 823 degrees K to the ambient room temperature, about 295 degrees Kelvin. The palladium-alloyed membrane having about 27 wt. % platinum (CSM 498H) was heated back up to a temperature of about 823 degrees K in nitrogen and the nitrogen leakage rate was found to be 60% higher than that taken before quenching. While not wanting to be bound by theory, it is believed that this increase in the nitrogen leakage rate indicates that the alloying of palladium with platinum suppresses hydride formation point well below 571 degrees Kelvin; the temperature at which palladium in an hydrogen atmosphere forms a hydride phase. FIG. 18A shows an image of the first unalloyed palladium control membrane (CSM 304) after it was unintentionally quenched in hydrogen to room temperature, the control membrane (CSM 304) cracked and delamination from the membrane support (see circled portion of the image). FIG. 18B shows a picture of the palladium-alloyed membrane having about 27 wt. % platinum (CSM 498H) after quenching in hydrogen, the membrane did not crack or delaminate from the membrane support. Furthermore, FIG. 18C is a scanning electron microscope image of the palladium-alloyed membrane having about 27 wt. % platinum (CSM 498H) surface after quenching in hydrogen and shows the absence of cracking on the microscopic scale.

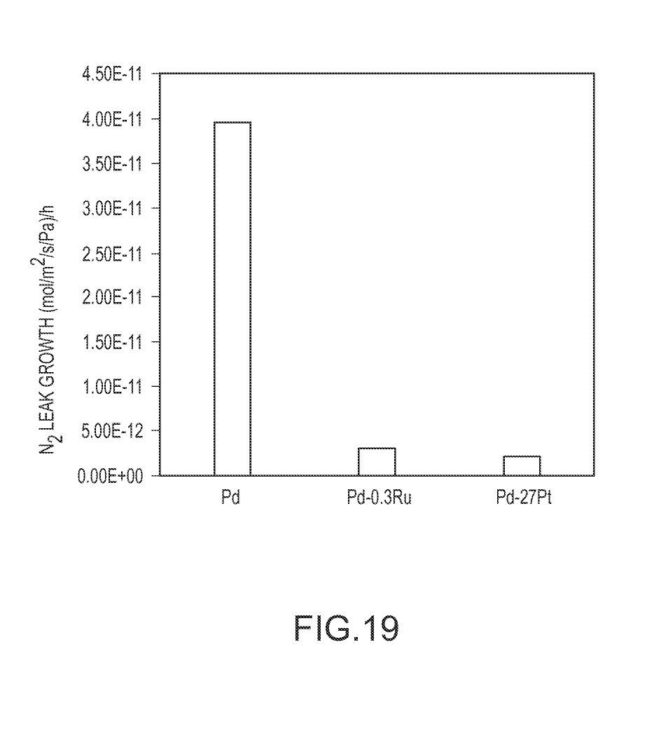

FIG. 19 shows a comparison of the rate of nitrogen leakage growth rate values at about 873 degrees Kelvin for an unalloyed palladium membrane, a palladium-alloyed membrane having about 0.3 wt. % ruthenium and a palladium-alloyed membrane having about 27 wt. % platinum. The alloying of palladium with a metal having a higher melting temperature substantially reduces the high temperature nitrogen leakage growth rate compared to an unalloyed palladium membrane.

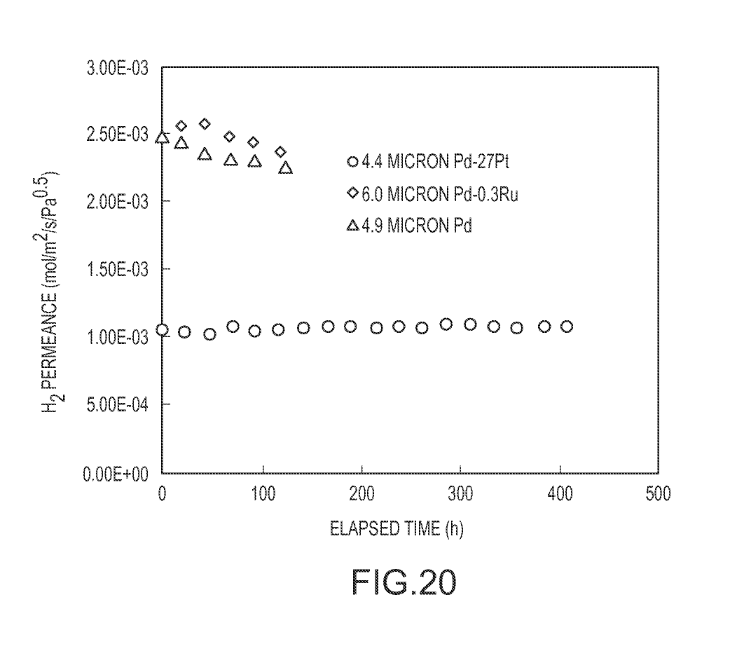

FIG. 20 shows a comparison of the hydrogen permeance at about 873 degrees Kelvin for the second unalloyed palladium membrane control (CSM 474H, designate by triangles), palladium-alloyed membrane having about 0.3 wt. % ruthenium (CSM 493H, designated by diamonds) and palladium-alloyed membrane having about 27 wt. % platinum (CSM 498H, designated by circles). The data show that the palladium-alloyed membrane having about 27 wt. % platinum (CSM 498H), why having a lower hydrogen permeance compared to either the unalloyed palladium membrane or the palladium membrane alloyed with 0.3 wt. % ruthenium, has a substantially more stable hydrogen permeance. Furthermore, the low hydrogen permeance for the palladium-alloyed membrane having 27 wt. % platinum had a lower hydrogen to nitrogen selectively of about 626 compared to the unalloyed palladium membrane, with a selectivity of 1,750, and the palladium-alloyed membrane having about 0.3 wt. % ruthenium (CSM 493H), with a selectivity of about 1,860 (Table III).

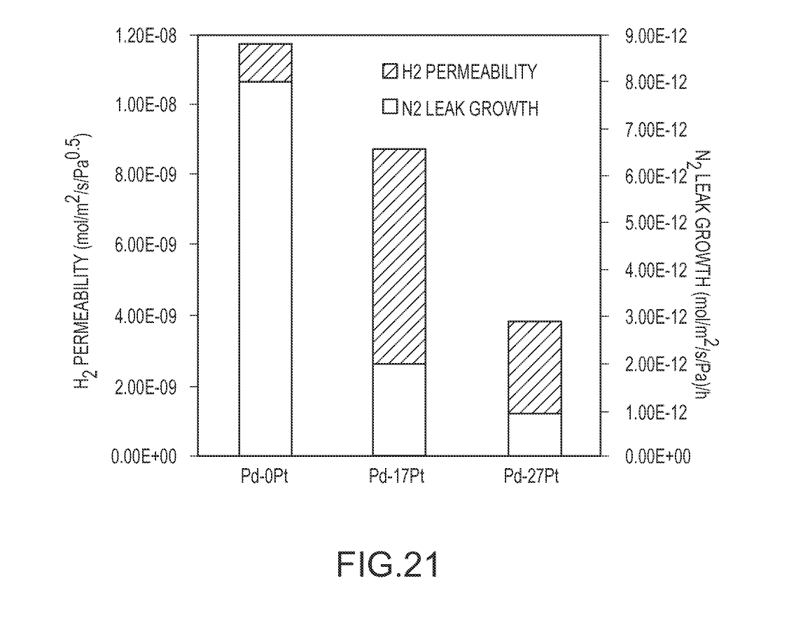

FIG. 21 shows the pure hydrogen permeability and nitrogen leakage growth rate for the second unalloyed palladium membrane control (CSM 474H) and two palladium-alloyed membranes having different levels of platinum, one having 17 wt. % platinum (CSM 473H) and the other 27 wt. % platinum (CSM 498H). By lowering the platinum content from 27 to 17% wt. % did not significantly increase nitrogen leakage growth rate (respectively increased from about 1×10¹² (mole/m²/s/Pa)/h to about 2×10⁻¹² (mole/m²/s/Pa)/h). However, the pure hydrogen permeance was enhanced from about 8.8×10⁻⁴ mole/m²/s/Pa^{0.5} to about 1.4×10⁻³ mole/m²/s/Pa^{0.5}, respectively. Moreover, a stable hydrogen permeance was also observed over the temperature range of from about 823 to about 873 degrees Kelvin.

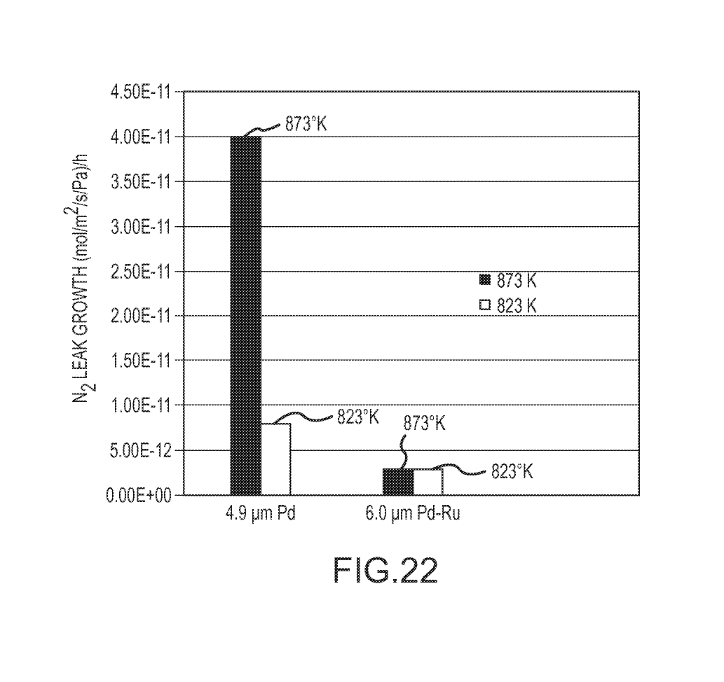

FIG. 22 shows a comparison of the nitrogen leakage growth rates in mol/m²/s/Pa)(h⁻¹) at about 823 and about 873 degrees Kelvin for the second unalloyed palladium membrane control (CSM 474H) and the palladium-alloyed membrane having about 0.3 wt. % ruthenium (CSM 493H). The data show that the unalloyed palladium membrane has substantially greater nitrogen leakage rates at about 823 and 873 degrees Kelvin than the palladium-alloyed membrane having about 0.3 wt. % ruthenium (CSM 493H). The palladium-alloyed membrane having about 0.3 wt. % ruthenium has substantially greater stability than the unalloyed palladium membrane at temperatures greater than about 823 degrees Kelvin.

A number of variations and modifications of the invention can be used. It would be possible to provide for some features of the invention without providing others.

The present invention, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for separating hydrogen from a hydrogen-containing fluid, comprising:
separating a hydrogen-containing fluid stream at a temperature from about 573 to about 1,173 degrees Kelvin into a permeate stream comprising substantially molecular hydrogen and a retenate stream substantially depleted of molecular hydrogen compared to the hydrogen-containing fluid stream by permeating hydrogen through a palladium-alloyed membrane having a nitrogen leakage growth rate at about 823 degrees Kelvin of no more than about 7×10⁻¹² (mol/m²/s/Pa)/h, and wherein the palladium-alloyed membrane comprises palladium and one or more of ruthenium, rhodium, iridium, platinum, silver, gold and osmium.

2. The method of claim 1, wherein the separating of the molecular hydrogen from the hydrogen-containing fluid stream is conducted in a steam reforming reactor at a pressure from about 0.1 to about 10 MPa and a space velocity of from about 50 to about 1,000 GHSV (h⁻¹).

3. The method of claim 1, wherein the permeated molecular hydrogen stream comprises at least about 80 mole % molecular hydrogen.

4. The method of claim 1 wherein the hydrogen-containing fluid stream is provided by one of a steam reforming reactor of a hydrocarbon, a steam reforming reactor of methane or a steam reforming reactor of an alcohol.

5. The method of claim 4, wherein the steam reforming reactor includes a catalyst for catalyzing molecular hydrogen production and wherein the catalyst is in the form of one of a fluidized or packed bed.

6. The method of claim 1, wherein the palladium-alloyed membrane is supported on one or more surfaces of a membrane support, and wherein the membrane support is porous and permeable, wherein an intermetallic material is positioned between the palladium-alloyed membrane and the membrane support, and wherein the intermetallic material comprises one or more of alumina, silica, zirconia, stabilized zirconias such as yttria or ceria stabilized zirconia, titania, ceria, silicon, carbide, chromium oxide, ceramic materials, and zeolites, wherein the intermetallic material is a diffusion barrier between the membrane support and the palladium-alloyed membrane.

7. The method of claim 6, wherein the membrane support is the form of one of a tube, a corrugated shape, a system of double-plates, a plate coiled as a double spiral, a plane, a curvilinear sheet, or flat disk.

8. The method of claim 1, wherein the palladium-alloyed membrane has an average thickness of from about 0.5 to about 15 μm.

9. The method of claim 1, wherein the palladium-alloyed membrane has a hydrogen permeance of from about 1×10⁻³ to about 1×10⁻² mol/m²/s/Pa^{0.5}.

10. The method of claim 1, wherein the palladium-alloyed membrane comprises palladium and one of about 0.5 wt. % ruthenium, about 17 wt. % platinum, and about 27 wt. % platinum.

11. A metallic membrane, comprising:
a palladium-alloyed membrane having an average thickness of from about 1 to about 10 μm and a nitrogen leakage growth rate at about 823 degrees Kelvin or more of no more than about 7×10⁻¹² (mol/m²/s/Pa)/h, and wherein the palladium-alloyed membrane comprises palladium and one or more of ruthenium, platinum, silver, gold and osmium.

12. The metallic membrane of claim 11, wherein the palladium-alloyed membrane has a hydrogen permeance of from about 1×10⁻³ to about 1×10⁻² mol/m²/s/Pa^{0.5}, and wherein the palladium-alloyed membrane comprises palladium and one of about 0.5 wt. % ruthenium, about 17 wt. % platinum, and about 27 wt. % platinum.

13. A method for purifying a fluid, comprising:
providing a gaseous fluid stream comprising molecular hydrogen, water, and one or both of carbon dioxide and carbon monoxide; and
contacting a palladium-alloyed membrane having a nitrogen leakage growth rate at about 823 degrees Kelvin of no more than about 7×10⁻¹² (mol/m²/s/Pa)/h with the gaseous fluid stream, wherein the contacting of the gaseous fluid steam the palladium-alloyed membrane:
i) occurs at a temperature of from about 573 to about 1,173 degrees Kelvin; and
ii) separates the gaseous fluid stream into a permeate stream comprising substantially molecular hydrogen and a retenate stream substantially depleted of the molecular hydrogen.

14. The method of claim 13, wherein the palladium-alloyed membrane comprises palladium and one or more of ruthenium, rhodium, iridium, platinum, silver, gold and osmium.

15. The method of claim 13, wherein the contacting of the gaseous fluid stream with the palladium-alloyed membrane is in a steam reforming reactor at a pressure selected from the group of pressures consisting of from about 0.1 to about 10 MPa, from about 0.5 to about 5 MPa, from about 1 to about 3 MPa, and from about 2 to about 3 MPa, wherein the contacting of the gaseous fluid stream with the palladium-alloyed membrane is in a steam reforming reactor at a temperature is selected from the group of temperatures consisting of from about 673 to about 1,173 degrees Kelvin, from about 773 to about 1,073 degrees Kelvin and from about 773 to about 973 degree Kelvin, and wherein the contacting of the gaseous fluid stream with the palladium-alloyed membrane is in a steam reforming reactor at a space velocity selected from the group of space velocities consisting of from about 60 to about 900 GHSV (h⁻¹), from about 70 to about 800 GHSV (h⁻¹), and from about 100 to about 700 GHSV (h⁻¹).

16. The method of claim 13, wherein the permeated molecular hydrogen stream comprises about 80 mole % molecular hydrogen or more.

17. The method of claim 13, wherein the gaseous fluid stream is provided by one of a steam reforming reactor of a hydrocarbon, a steam reforming reactor of methane or a steam reforming reactor of an alcohol.

18. The method of claim 13, wherein the palladium-alloyed membrane is supported on one or more surfaces of a membrane support, and wherein the membrane support is porous and permeable, wherein an intermetallic material is positioned between the palladium-alloyed membrane and the membrane support, wherein the intermetallic material comprises one or more of alumina, silica, zirconia, stabilized zirconias such as yttria or ceria stabilized zirconia, titania, ceria, silicon, carbide, chromium oxide, ceramic materials, and zeolites, wherein the membrane support may be selected from the group consisting of 301, 304, 305, 316, 317, and 321 series of stainless steels, HASTELLOY™ B-2, C-4, C-22, C-276, G-30, X and others, and INCONEL™ alloys 600, 625, 690, and 718, and wherein the membrane support is the form of one of a tube, corrugated shape, a system of double-plates, a plate coiled as a double spiral, plane, a curvilinear sheet, or flat disk.

19. The method of claim 13, wherein the palladium-alloyed membrane has an average thickness of from about 0.5 to about 15 the palladium-alloyed membrane has a hydrogen permeance of from about 1×10⁻³ to about 1×10⁻² mol/m²/s/Pa^{0.5}.

20. The method of claim 13, wherein the palladium-alloyed membrane comprises palladium and one of about 0.5 wt. % ruthenium, about 17 wt. % platinum, and about 27 wt. % platinum.

21. A device, comprising:
a shell;
a membrane position in the shell to form a permeate volume and a renate volume;
an inlet configured for introducing a first gaseous stream to the permeate volume; and
a first outlet configured to exhaust substantially pure molecular hydrogen from the permeate volume, wherein the membrane comprises a palladium-alloyed membrane having a nitrogen leakage growth rate at about 823 degrees Kelvin or more of no more than about 7×10⁻¹² (mol/m²/s/Pa)/h.
